(19) United States
(12) Patent Application Publication
(10) Pub. No.: US 2026/0255372 A1
(43) Pub. Date: Aug. 27, 2026

(54) METHODS AND APPARATUSES FOR MULTIPLE ACCESS POINT COORDINATED PROCEDURE

(71) Applicant: InterDigital Patent Holdings, Inc., Wilmington, DE (US)

(72) Inventors: Hanqing Lou, Syosset, NY (US); Xiaofei Wang, North Caldwell, NJ (US); Mahmoud Saad, L’Ile Bizard (CA); Ying Wang, Easton, PA (US); Rui Yang, Greenlawn, NY (US)

(21) Appl. No.: 19/064,071

(22) Filed: Feb. 26, 2025

(51) Int. Cl. H04W 72/27; H04W 16/14; H04W 88/08

(52) U.S. Cl. CPC H04W 72/27; H04W 16/14; H04W 88/08

(57) ABSTRACT

Methods, architectures, apparatuses, and systems directed to multi-access point (MAP) coordinated procedure are described. A wireless station (STA) may be configured to receive, from a first Access Point (AP), a first frame that indicates Multiple Access Point (MAP) coordination information corresponding to the first AP and one or more second APs and to transmit, to the first AP, a second frame that indicates one or more MAP coordination schemes associated with one or more of the first and the second APs. A first Access Point (AP) may be configured to transmit, to one or more wireless Stations (STA), a first frame that indicates MAP coordination information corresponding to the first AP and one or more second APs and to receive, from one or more wireless Stations (STA), a second frame that indicates one or more MAP coordination schemes associated with one or more of the first and the second APs.

### TECHNICAL FIELD

The present disclosure is generally directed to the fields of communications, software and encoding, including methods, architectures, apparatuses, and systems directed to multiple access point (MAP) coordinated setup procedure in wireless local area network (WLAN), such as Wi-Fi system.

### BACKGROUND

A WLAN in infrastructure basic service set (BSS) mode has an access point (AP) for the BSS and one or more stations (STAs) associated with the AP. The AP may have access or interface to a distribution system (DS) or another type of wired/wireless network carrying traffic in and out of the BSS. Embodiments described herein have been designed with the foregoing in mind.

### SUMMARY

Methods, architectures, apparatuses, and systems directed to multiple access point (MAP) coordinated (MAPC) setup procedure in WLAN system are described herein. In an embodiment, wireless station (STA) may be configured to receive, from a first Access Point (AP), a first frame that indicates Multiple Access Point (MAP) coordination information corresponding to the first AP and one or more second APs and to transmit, to the first AP, a second frame that indicates one or more MAP coordination schemes associated with one or more of the first and the second APs. In an embodiment, first Access Point (AP) may be configured to transmit, to one or more wireless Stations (STA), a first frame that indicates MAP coordination information corresponding to the first AP and one or more second APs and to receive, from one or more wireless Stations (STA), a second frame that indicates one or more MAP coordination schemes associated with one or more of the first and the second APs. The one or more second APs may Overlap Basic Service Set (OBSS) APs with the first AP.

In an embodiment, the STA is configured to determine one or more received signal characteristics from the first AP and the one or more second APs and to transmit, to the first AP, the determined one or more received signal characteristics based on the one or more MAP coordination schemes indicated in the second frame. In an embodiment, determining one or more signal characteristics includes measurement of one or more received signal characteristics from the first AP and the one of more second APs. The one or more received signal characteristics may be associated with one or more MAP coordination schemes indicated in the second frame.

In an embodiment, the STA is configured to receive, from the first AP, a poll frame and the second frame may be transmitted in response to the poll frame. In another embodiment, the second frame may be transmitted without any solicitation from the first AP.

In an embodiment, the one or more coordination schemes includes at least one of coordinated spatial reuse (Co-SR), coordinated beamforming (Co-BF), coordinated restricted target wake time scheme (Co-RTWT), coordinated Time Division Multiple Access (Co-TDMA) and coordinated non-primary channel access (Co-NPCA).

In an embodiment, the second frame may indicate that the STA may participate to one or more MAP coordination schemes.

In an embodiment, the first frame is a broadcast management frame.

In an embodiment, the STA and/or the AP is configured to enable or disable one or more MAP coordination schemes.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A is a diagram illustrating an example of multiple access point coordinated procedure.

FIG. 2B is a diagram illustrating an example MAPC setup procedure;

FIG. 3 is a diagram illustrating an example MAPC request/response procedure; and

FIG. 4 is a diagram illustrating an example method for MAP coordinated setup, implemented in an AP.

FIG. 5 is a network example including multiple access points.

FIG. 6 is a diagram illustrating an example of MAPC Announcement procedure.

FIG. 7 is a network example including multiple access points.

FIG. 8 is a diagram illustrating an example method for coordination procedure.

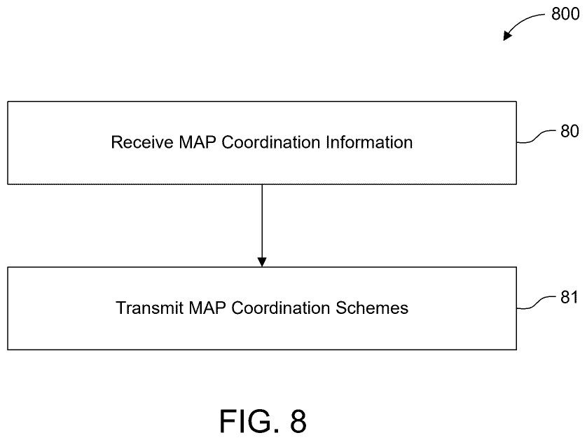

FIG. 9 is a diagram illustration MAPC procedure between an access point and a station.

FIG. 10 illustrates MAPC schemes.

FIG. 11 is a diagram illustrating MAPC procedure associated with an access point and stations.

FIG. 12 is a diagram illustrating MAPC announcement by an access point and MAPC notification by a station.

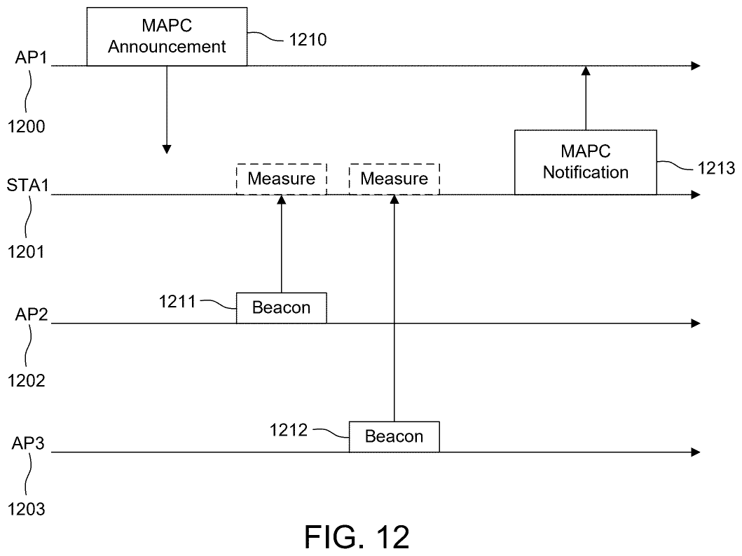

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

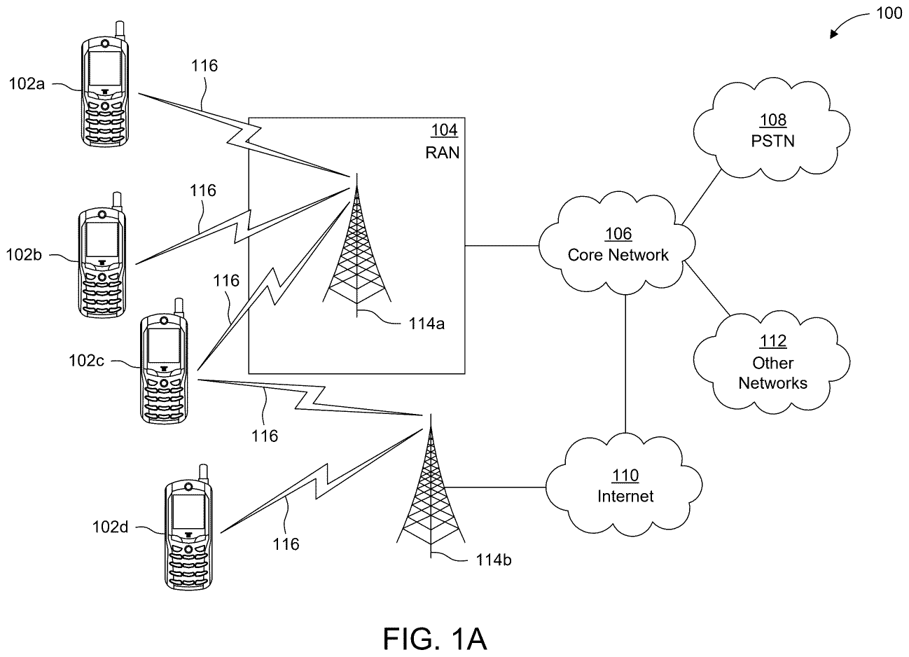

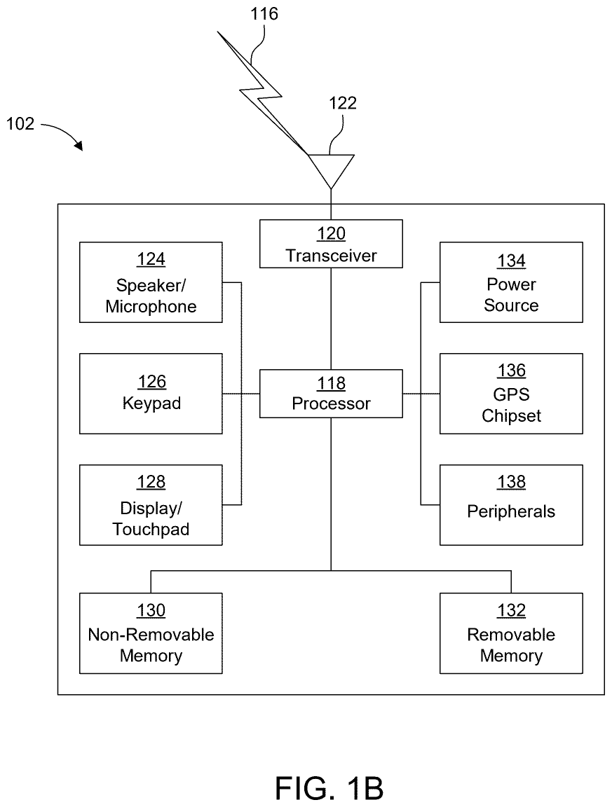

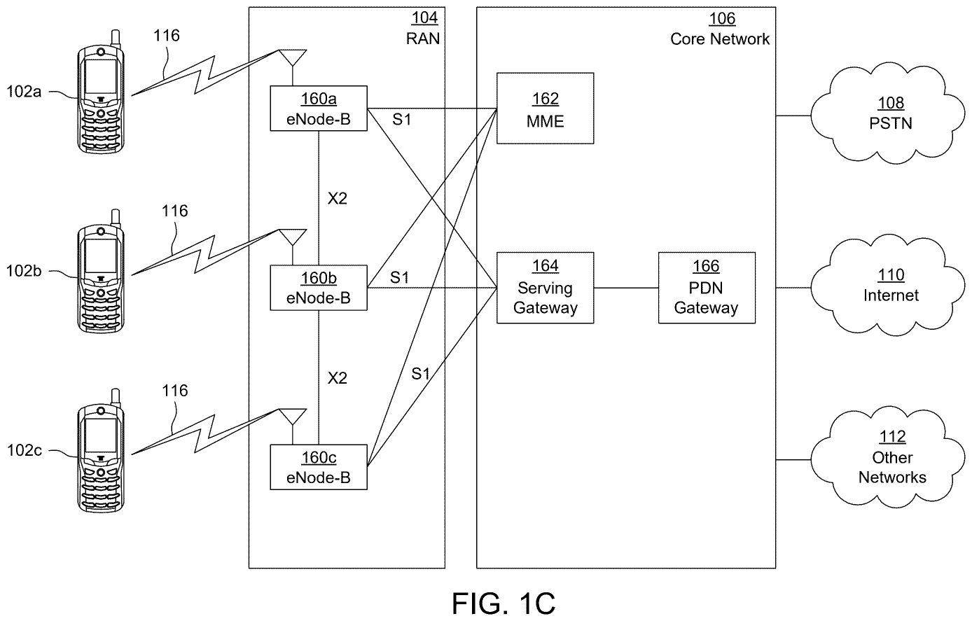

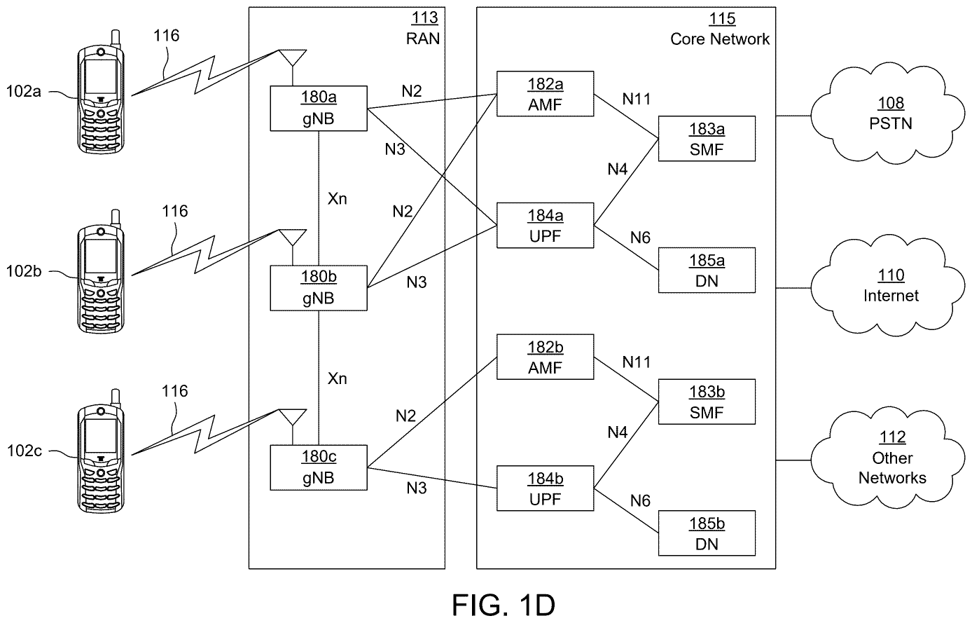

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as Institute of electrical and electronics engineers (IEEE) 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (e.g., contiguous, or non-contiguous), one or more subchannels within a channel, one or more resource units (RUs) within an orthogonal frequency division multiple access (OFDMA) system, whereby assigned one or more RUs may be adjacent (e.g., contiguous) or non-contiguous, occupying one or more channels or subchannels, etc.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the medium access control (MAC) layer, entity, etc.

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”. Throughout embodiments described herein, the expression “the WTRU may provide (/be provided) with a set of parameters (/something)” is equivalent or may be used interchangeably with “the WTRU may transmit (/receive) information indicating a set of parameters (/something)”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

In embodiments described herein, “list of”, “set of” and “one or more of” may be used interchangeably.

In embodiments described herein, “identity” and “identifier” may be used interchangeably to refer to how a network element (or a WTRU) may be identified.

In embodiments described herein, a STA may refer to any of an AP STA and a non-AP STA. The architecture depicted at FIG. 1B for a WTRU 102 may be applicable more generally to any of an AP STA and a non-AP STA.

In embodiments described herein, the terms AP and AP STA may be used interchangeably.

In embodiments described herein, the terms frame and transmission may be used interchangeably.

In embodiments described herein, a transmission opportunity (TXOP) may refer to an interval of time during which a particular (e.g., quality-of-service (QoS)) STA may (e.g., have the right to) initiate frame exchange sequences onto the wireless medium (WM).

In embodiments described herein, a trigger based physical layer protocol data unit (TB PPDU) may refer to a PPDU transmitted with any of high efficiency (HE) TB PPDU (HE TB PPDU) format or extremely high throughput (EHT) TB PPDU (EHT TB PPDU) format.

In embodiments described herein, a non-HT PPDU may refer to a non-high-throughput PPDU, which is transmitted using a PPDU format.

In embodiments described herein, a non-HT duplicate PPDU may refer to a non-high-throughput duplicate PPDU, where a single data frame may be duplicated and sent across multiple 20 MHz channels simultaneously.

In embodiments described herein, an overlapping basic service set (OBSS) may refer to a basic service set (BSS) operating on the same channel as the station's BSS and within (partly or wholly) its basic service area (BSA).

In embodiments described herein, a basic service set (BSS) color (BSS color) may refer to an identifier for a BSS or for a set of BSSs belonging to a multiple basic service set identifier (BSSID) set or a co-hosted BSSID set.

For the sake of clarity, embodiments are described herein with 20 MHz as an example of subchannel. Embodiments described herein are not limited to 20 MHz subchannels and may be applicable to subchannels of any size of the PPDU bandwidth (e.g., 40 MHz or any other size).

In embodiments described herein the terms “transmit power upper/lower bound”, “transmit power maximum/minimum value”, “transmit power threshold”, “maximum/minimum transmit power” may be used interchangeably to refer to any power value threshold.

In embodiments described herein, the terms “initiating AP”, “requesting AP” and “first AP” (collectively “AP”) may be used interchangeably to refer to any AP in a MAPC group that may initiate a MAPC setup procedure.

In embodiments described herein, the terms “neighboring AP”, “responding AP” and “second AP” may be used interchangeably to refer to any AP in a MAPC group that may participate in a MAPC setup procedure.

For the sake of clarity, embodiments are described herein with the examples of (e.g., MAPC) announcement, (e.g., MAPC) request and (e.g., MAPC) response frames. Embodiments described herein are not limited to (e.g., MAPC) announcement, (e.g., MAPC) request and (e.g., MAPC) response frames. Any frames (which may be referred to as first/second/third frames) may be applicable to embodiments are described herein.

A WLAN in infrastructure basic service set (BSS) mode has an access point (AP) for the BSS and one or more stations (STAs) associated with the AP. The AP may have access or interface to a distribution system (DS) or another type of wired/wireless network carrying traffic in and out of the BSS. Traffic to STAs originating from outside the BSS may arrive through the AP and may be delivered to the STAs. Traffic originating from STAs to destinations outside the BSS may be sent to the AP to be delivered to the respective destinations. Traffic between STAs within the BSS may (e.g., also) be sent through the AP where the source STA may send traffic to the AP and the AP may deliver the traffic to the destination STA. Traffic between STAs within a BSS may be referred to as peer-to-peer traffic. Such peer-to-peer traffic may (e.g., also) be sent directly between the source and destination STAs with a direct link setup (DLS) using an IEEE 802.11e DLS or an IEEE 802.11z tunneled DLS (TDLS). A WLAN using an independent BSS (IBSS) mode has no AP, and/or STAs, communicating directly with each other. This mode of communication may be referred to as an “ad-hoc” mode of communication.

Using the IEEE 802.11ac infrastructure mode of operation, the AP may transmit a beacon on a fixed channel, e.g., the primary channel. This channel may be 20 MHz wide and may be the operating channel of the BSS. This channel may be used by the STAs to establish a connection with the AP. The channel access mechanism in an IEEE 802.11 system is based on carrier sense multiple access with collision avoidance (CSMA/CA). In this mode of operation, a (e.g., every) STA, including the AP, may sense occupancy or vacancy of the primary channel. If the channel is detected to be busy, the STA may back off. Hence only one STA may transmit at any given time in a given BSS.

In IEEE 802.11n (described in IEEE P802.11-REVme/D7.0), high throughput (HT) STAs may also use a 40 MHz wide channel for communication. This is achieved by combining the primary 20 MHz channel, with an adjacent 20 MHz channel to form a 40 MHz wide contiguous channel.

In IEEE 802.11ac (described in IEEE P802.11ax/D8.0), very high throughput (VHT) STAs may support 20 MHz, 40 MHz, 80 MHz, and 160 MHz wide channels. The 40 MHz, and 80 MHz, channels may be formed by combining contiguous 20 MHz channels similar to IEEE 802.11n described herein. A 160 MHz channel may be formed by combining eight contiguous 20 MHz channels, or by combining two non-contiguous 80 MHz channels, which may also be referred to as an 80+80 configuration. For the 80+80 configuration, at the transmitter, the data, after channel encoding, may be passed through a segment parser that may divide it into two streams. IFFT and time domain processing may be done on a (e.g., each) stream separately. The streams may be mapped on to the two channels, and the data may be transmitted. At the receiver, this mechanism is reversed, and the combined data may be sent to the MAC.

Sub 1 GHz modes of operation are supported by IEEE 802.11af, and IEEE 802.11ah. For these specifications the channel operating bandwidths, and carriers, are reduced relative to those used in IEEE 802.11n, and IEEE 802.11ac. IEEE 802.11af supports 5 MHz, 10 MHz and 20 MHz bandwidths in the television (TV) white space (TVWS) spectrum, and IEEE 802.11ah supports 1 MHz, 2 MHz, 4 MHz, 8 MHz, and 16 MHz bandwidths using non-TVWS spectrum. An example of use case for IEEE 802.11ah may include support for meter type control (MTC) devices in a macro coverage area. MTC devices may have limited capabilities including (e.g., only) support for limited bandwidths, and may include a requirement for a very long battery life.

WLAN systems which may support multiple channels, and channel widths, such as IEEE 802.11n, IEEE 802.11ac, IEEE 802.11af, and IEEE 802.11ah, may include a channel which may be referred to as the primary channel. The primary channel may have, for example, a bandwidth equal to the largest common operating bandwidth supported by (e.g., all) STAs in the BSS. The bandwidth of the primary channel may be limited by the STA, among the STAs operating in a BSS, which may support the smallest bandwidth operating mode. In the example of IEEE 802.11ah, the primary channel may be 1 MHz wide if there are STAs (e.g. MTC type devices) that (e.g., only) support a 1 MHz mode (e.g., even) if the AP, and other STAs in the BSS, may support any of 2 MHz, 4 MHz, 8 MHz, 16 MHz, or other channel bandwidth operating modes. In an example, (e.g., all) carrier sensing, and NAV settings, may depend on the status of the primary channel; e.g., if the primary channel is busy, for example, due to a STA supporting (e.g., only) a 1 MHz operating mode being transmitting to the AP, then the (e.g., entire) available frequency bands may be considered busy e.g., even though majority of it stays idle and available.

In the United States, the available frequency bands which may be used by IEEE 802.11ah are from 902 MHz to 928 MHz. In Korea the available frequency bands may be from 917.5 MHz to 923.5 MHz; and in Japan, the available frequency bands may be from 916.5 MHz to 927.5 MHz. The total bandwidth available for IEEE 802.11ah may be from 6 MHz to 26 MHz depending on the country code.

Ultra-high reliability (UHR) study group is described herein.

The IEEE 802.11 ultra-high reliability (UHR) study group was formed in September 2022. UHR is considered as the next major revision to IEEE 802.11 standards following 802.11be. UHR is formed to explore the possibility to improve reliability, support low latency traffic and further increase peak throughput and improve efficiency of the IEEE 802.11 networks. Several new features are discussed in 802.11bn and some related features are described herein.

Coordinated multiple AP (MAP) transmissions are accepted as a new feature to IEEE 802.11bn. Coordinated MAP schemes under consideration include coordinated spatial reuse (Co-SR), coordinated beamforming (Co-BF), coordinated restricted target wake time scheme (Co-RTWT), and coordinated TDMA (Co-TDMA). IEEE 802.11bn may accept other coordinated MAP schemes at a later point.

Non-primary channel access (NPCA) mechanism may allow an AP or non-AP STAs to transmit or receive frames on one or more secondary subchannels when the primary subchannel is busy or occupied at any of the transmitter side and the receiver side. NPCA was accepted as a new feature for IEEE 802.11bn.

Dynamic subchannel operation (DSO) may allow an AP to allocate a non-AP STA to operate on a subchannel dynamically. The subchannel may be out of the operation channel width of the non-AP STA. For example, the non-AP STA may be a 20 MHz STA, and the subchannel the AP allocated may not be the primary 20 MHz of the non-AP STA. DSO is currently under discussion in IEEE 802.11bn.

A Block Ack (BA) frame format is described herein.

A Block Ack (BA) frame may be used to carry acknowledgement to a previously transmitted frame. Multi-STA BlockAck (M-BA) is a variant of BA frame. In 802.11bn [4] it is repurposed to carry downlink and uplink unavailability information. The frame format is BA is shown in Table 1.

TABLE 1
Block Ack (BA) format.

| | | | | | | |
|---|---|---|---|---|---|---|
| Frame | Duration | RA | TA | BA | BA | FCS |
| Control | | | | Control | Information | |

The BA Control field is shown in Table 2. The BA Ack Policy subfield of the BA Control field may be used in HT-Delayed agreement. The BA Type subfield may indicate whether it is a M-BA or other types of BA, such as Compressed BA, Multi_TID BA etc. The TID_INFO subfield of the BA Control field of the M-BA frame is reserved in IEEE P802.11-REVme/D7.0. AID refers to Association ID. TID refers to Traffic Identity.

TABLE 2
BA Control field format defined in IEEE P802.11ax ™/D8.0.

| | | | |
|---|---|---|---|
| BA Ack Policy | BA Type | Reserved | TID_INFO |

The BA Information field of the Multi-STA BlockAck frame may comprise one or more Per AID TID Info subfields. The Per AID TID Info subfield is shown in Table 3 if the AID11 subfield carried in the AID TID Info subfield is not 2045.

TABLE 3
Per AID TID Info subfield format if
the AID11 subfield is not 2045.

| | | |
|---|---|---|
| AID TID Info | Block Starting Sequence Control | Block Ack Bitmap |

The AID TID Info subfield is defined in Table 4. Based on IEEE P802.11-REVme/D7.0, The AID11 subfield may carry the 11 LSBs of the AID of the non-AP STA for which the Per AID TID Info subfield is intended. The format of the Per AID TID Info subfield may depend on the value of the AID11 subfield. If the Multi-STA BlockAck frame is sent to an AP, the AID11 subfield is set to 0. A value of 2045 in the AID11 subfield is used as an identifier for any unassociated STA. If the AID11 subfield is set to 2045, then the Ack Type subfield and TID subfield are set to 0 and 15, respectively.

TABLE 4
AID TID Info subfield format.

| | | |
|---|---|---|
| AID11 | Ack Type | TID |

The setting for Block Starting Sequence Control subfield and Block Ack Bitmap subfield depends on the setting of the AID TID Info subfield.

MAP coordination (MAPC) may be considered in IEEE 802.11bn. Embodiments described herein may allow a plurality of APs to negotiate and setup one or more coordinated transmissions.

Frame/field/element format is described herein.

General element format is described herein.

Table 5 describes an element format.

TABLE 5
Element Format.

| | | | |
|---|---|---|---|
| Element ID | Length | Element ID Extension | Information |

The element ID field and the element ID extension field (if present) may be used to identify the element. The length field may indicate the number of octets in the element e.g., excluding the element ID and length fields. The information field may carry the information for the element.

A general action frame format is described herein.

Action frames may comprise management frame with (e.g., special, dedicated) format. The MAC frame body of an action frame may have a general format as shown in Table 2. The “category” field may describe the action frame type, such as high efficiency (HE) actions frame, EHT action frame etc. The second field, e.g., referred to as “xxx Action” field shown in Table 6, may depend on the category. For example, if the category field indicates an EHT action frame, the second field may be an EHT action field, which may indicate a finer (e.g., more detailed) type of the action frame under the EHT category. There may be one or more fields followed which may carry the detailed information for the action frame.

TABLE 6
Action frame format.

| Order | Meaning |
|---|---|
| 1 | Category |
| 2 | xxx Action |
| . . . | . . . |

With UHR amendment, a protected UHR action frame category may be defined as shown in Table 7 where the category field may indicate a protected UHR action frame. The protected UHR action field e.g., after the category field may differentiate further detailed protected UHR action frames.

TABLE 7
Action frame format with protected UHR category.

| Order | Meaning |
|---|---|
| 1 | Category |
| 2 | Protected UHR Action |
| . . . | . . . |

A UHR action frame category is shown in Table 8 where the category field may indicate a UHR action frame. The UHR action field e.g., after the category field may differentiate further detailed UHR action frames.

TABLE 8
Action frame format with UHR category.

| Order | Meaning |
|---|---|
| 1 | Category |
| 2 | UHR Action |
| . . . | . . . |

A Public action frame may be an action frame with the Category field that may indicate a Public Action frame. The Public Action field right after the Category field may differentiate the detailed Public Action frames.

General terminologies used in Wifi is described herein:
PPDU: physical layer (PHY) protocol data unit.
Non-HT PPDU: non-high-throughput PPDU, which is transmitted using a PPDU format defined in Clause 15-18 of IEEE P802.11-REVme/D7.0.
Non-HT duplicate PPDU: non-high-throughput duplicate PPDU, where a single data frame is duplicated and sent across multiple 20 MHz channels simultaneously.
NDPA: null data physical layer (PHY) protocol data unit (PPDU) Announcement frame.

Multi-AP coordinated transmission setup is described herein.

A general MAPC setup procedure is described herein.

Multi-AP coordination (MAPC) transmission schemes may include multiple APs and a set of schemes and procedures to enable coordinated usage of the resources such as e.g., any of time, frequency, spatial etc.

Exemplary MAPC schemes may include any of Co-SR, Co-BF, Co-TDMA, Co-RTWT, and Co-NPCA (coordinated non-primary channel access). The Co-SR, Co-BF, Co-TDMA and Co-RTWT are described in “Specification Framework for TGbn” IEEE 802.11-24/0209r5, published by YU in September 2024. Co-NPCA is a MAP coordinated scheme which may allow a first (e.g., coordinating or sharing) AP to request or suggest one or more second (e.g., coordinated or shared) APs and/or their associated STAs to switch to monitor and operate on a non-primary channel. Co-NPCA may also be referred to as any of coordinated FDMA (C-FDMA), coordinated orthogonal FDMA (C-OFDMA), coordinated dynamic subchannel operation (C-DSO) or any other equivalent name.

A general MAPC setup procedure may be used to setup any of the coordinated MAP schemes.

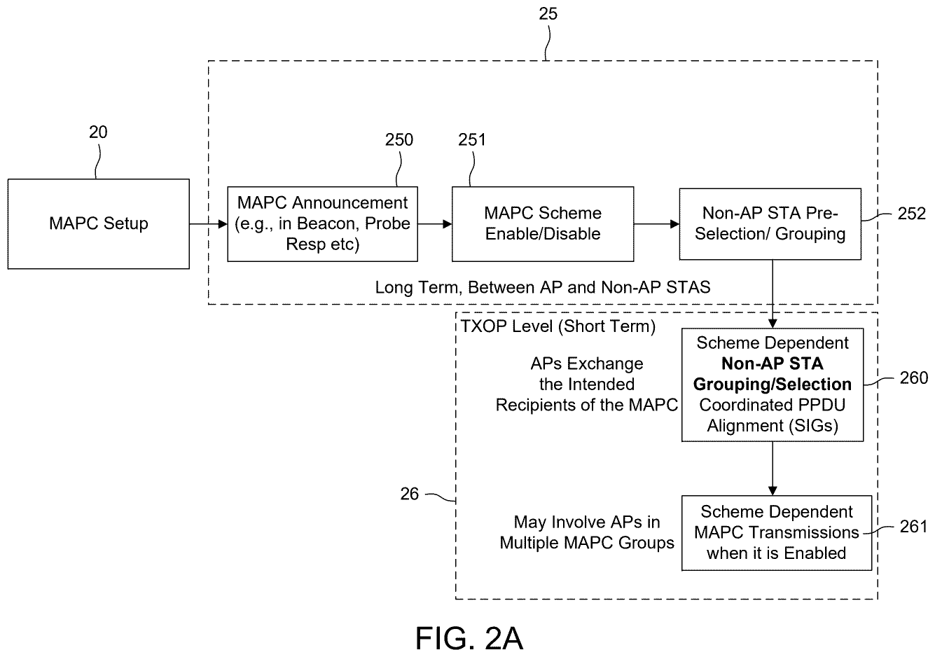

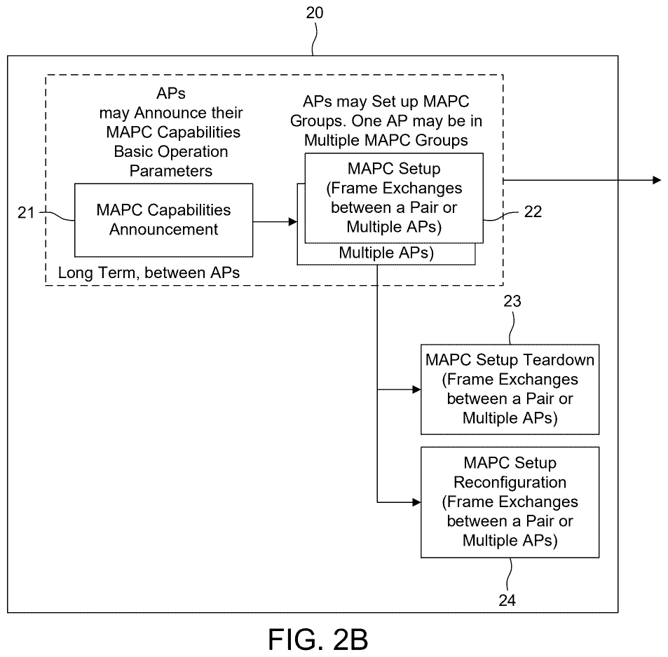

FIG. 2B is a diagram illustrating an example MAPC setup procedure 20.

MAPC capabilities and parameters announcement is described herein. As shown at 21, an AP which may have MAPC capability and may enable the MAPC scheme may advertise (e.g., send information indicating) any of its MAPC capabilities, one or more (e.g., basic) operation parameters and one or more MAPC parameters to its neighboring APs. This may be considered as the announcement for neighboring APs to perform MAPC discovery. An AP may plan MAPC setup after it may have received one or more MAPC capabilities and parameters announcement from its neighboring AP(s). In one example, the MAPC capability announcement may be based on BSS level signaling which may be transmitted once to multiple times in a beacon interval. In another example, it may be transmitted once per several beacon interval.

Pairwise or groupwise MAPC negotiation is described herein. This procedure may happen between a pair of APs or a group of APs. The procedure may result in initiating/adding/removing/modifying configurations of an MAPC group. One AP may have multiple MAPC negotiations with different APs. For example, a first AP (e.g., AP0) may have MAPC negotiation with a second AP (e.g., AP1) which may result in a first MAPC group. Meanwhile, the first AP (e.g., AP0) may have MAPC negotiation with a third AP (e.g., AP2) which may result in a second MAPC group. Besides AP0 and AP2, the second MAPC group may have one or more additional APs so that it may be a multi-AP group beyond one pair (e.g., with more than two APs).

MAPC setup is described herein. As shown at 22, an AP may send a request frame (e.g., MAPC request frame) to one or more APs to request MAPC transmissions. The AP may receive a response frame (e.g., MAPC response frame) from one or more APs. The frame exchanges may be used to exchange any of MAPC parameters, MAPC schemes, APs capabilities, operating parameters etc. After the successful negotiation between a pair of APs or a group of APs, an MAPC group may be formed, and MAPC group identifier (ID) may be used to (e.g., uniquely) identify the MAPC. An (e.g., each) AP in the MAPC group may have an AP ID which may be used to identify the AP. An MAPC group may support one or more MAPC schemes. An AP may have (e.g., belong to) more than one MAPC groups.

MAPC setup teardown is described herein. As shown at 23, an AP may request to tear down an MAPC setup any time after the setup may have been completed. After the MAPC setup teardown, if the AP want to perform MAPC transmissions later, it may (e.g., need to) go through the MAPC setup procedure again.

MAPC Setup reconfiguration is described herein. As shown at 24, an AP may request to reconfigure its MAPC parameters with one or more APs. This may happen when one or more APs withdraw from the MAPC group while other group members may remain, or when the channel conditions or geographical configurations among the MAPC group members change. In one example, the reconfiguration may allow the AP(s) to modify a subset of parameters negotiated/agreed before.

MAPC announcement is described herein.

FIG. 2A is diagram illustrating an example of multiple access point coordinated procedure. An example of Long term procedure 25 AP and non-AP stations is described herein and may include a MAPC announcement (e.g. in beacon, probe response, (re) association response . . . ) 250, an MAPC scheme Enable/Disable 251 and a station (for example, a non-access point (non-AP) station preselection and/or grouping 252. Long term procedure 25 follows MAPC set up 20. MAPC setup 20 may be a procedure involving multiple APs. The APs may exchange capability information and operation parameters and negotiate the coordinated parameters through different methods and frame exchanges. One example is provided in FIG. 2B.

APs may advertise MAPC groups and corresponding parameters to their associated stations, STAs through MAPC announcement 250. As shown at 250, an AP may advertise agreed MAPC groups and MAPC schemes it set up to its associated non-AP STAs. The MAPC Announcement 250 may include corresponding parameters to their associated STAs. The MAPC announcement may be carried in Beacon frames, Probe Response frames, and/or (Re) Association Response frame or other type of frames. In the case, the AP may be affiliated with an AP MLD, the MAPC announcement may be carried in the Multi-link element or Reduced Neighbor Report (RNR) element and transmitted on another link so that a non-AP STA associated with an AP affiliated with the same AP MLD on the other link may know the MAPC parameters of the AP.

MAPC scheme enabling/disabling is described herein. As shown at 251, an AP in one or more MAPC agreements may enable or disable a MAPC scheme based on its traffic condition, network condition, channel condition etc. for its BSS. In one method, the enabling/disabling is per scheme basis. For example, a MAPC group may setup with multiple MAPC schemes, e.g., Co-BF, Co-TDMA. An AP in the MAPC group may disable one or more MAPC schemes, e.g., disabling Co-BF. In one method, the enabling/disabling is per MAPC agreement basis. An AP may enable or disable one or more MAPC agreements based on its traffic conditions, network condition, channel condition etc. Once the MAPC scheme/agreement is disabled, the AP may be able to enable it in a future time without the needs to go through the MAPC setup procedure again. The AP may include the MAPC scheme/agreement enabling/disabling in the MAPC Announcement so non-AP STAs may notice the updated MAPC services provided by the AP. The MAPC scheme/agreement enabling/disabling indication may be carried in management frames such as Beacon frames, Probe Response frames, and/or (Re) Association Response frames or other type of frames.

For example, a station (STA) may comprise circuitry, including a transmitter, a receiver, a processor, and memory, and configured to receive, from a first Access Point (AP), a first frame 250 that indicates Multiple Access Point (MAP) coordination information corresponding to the first AP and one or more second APs and to transmit, to the first AP, a second frame 251 that indicates one or more MAP coordination schemes associated with one or more of the first and the second APs. In an embodiment, an apparatus may implement the corresponding method. In an embodiment, the first frame is a broadcast or unicast management frame. Similarly, a first Access Point (AP) may comprise circuitry, including a transmitter, a receiver, a processor, and memory, and configured to transmit, to one or more wireless Stations (STA), a first frame 250 that indicates MAP coordination information corresponding to the first AP and one or more second APs; and to receive, from one or more wireless Stations (STA), a second frame 251 that indicates one or more MAP coordination schemes associated with one or more of the first and the second APs. In an embodiment, an apparatus may implement the corresponding method.

For example:

Non-AP STAs may transmit MAPC Notification to its associated AP.
A non-AP STA, which successfully received the MAPC announcement may notify its associated AP its capability and intention to participate one or more MAPC schemes.
A non-AP STA which is capable of a MAPC scheme may enable or disable the MAPC scheme based on its traffic condition, network condition, channel condition, battery power condition etc. The non-AP STA may include the enabling/disabling information in the MAPC Notification.
Necessary channel sounding/measurement for the corresponding MAPC schemes may be performed before the notification transmission. The measurement results may be included in the MAPC Notification. In one example, Co-BF and Co-SR potential users may perform the measurement based on the received Beacon frame from the coordinated APs. In one example, Co-BF and Co-SR potential users may start corresponding MAPC sounding procedure. APs may use the measurement results to pre-select/pair/group non-AP STAs to perform the MAPC schemes.

Non-AP STA selection/grouping is described herein. The STA may be a non-AP station, i.e. that it has no AP capabilities. In an embodiment, the STA may have AP capabilities that are not involved in the processes as disclosed here without departing from the scope of the invention. As shown at 252, each AP in the MAPC group may select one or more non-AP STAs which may participate an enabled MAPC scheme in an upcoming TXOP or a sequence of TXOPs. The non-AP STA selection step may be MAPC scheme dependent. For some schemes (e.g., Co-TDMA, Co-RTWT), the selection step may be straightforward or even skipped since almost all the non-AP STAs which are capable of the coordinated scheme may be able to participate. For some schemes such as Co-BF, Co-SR, not all capable non-AP STAs are good candidates for the coordinated transmission. In an embodiment, STA preselection and/or grouping 252 may be needed for Co-BF and Co-SR. This may happen before TXOP or within TXOP. To perform Co-BF, APs may need to null the unintended STAs and at the same time beamform to the intended STAs. The scheme has constraints in the spatial domain. If the intended STA and non-intended STA(s) are in the same beam direction of an AP, the AP may not be able to beamform to the intended STA while nulling the unintended STA(s) and thus Co-BF may not work for those STAs. To perform Co-SR, APs may need to adjust transmit power such that the intended STA may be able to receive its signal while the unintended STA(s) may treat the signal as an interference. If the interference level to the unintended STA(s) is too high such that they may not receive their desired signal, the Co-SR scheme may not work for those STAs. To these kinds of MAPC schemes, the non-AP STA selection may be needed. In one method, two level of non-AP STA selection/grouping may be performed. The first level may be a long-term pre-selection/grouping procedure which may be performed during the MAPC Announcement and Notification procedure. The long-term procedure 25 may result in a list of non-AP STAs which may be suitable for one or more MAPC schemes. The second level may be a short-term selection/grouping procedure which may be performed during MAPC TXOP level transmission 26.

Transmission opportunity (TXOP) level MAPC transmission is described herein as shown at 26. In one method, an AP may acquire the wireless medium, the AP may determine to allow MAPC operation in the TXOP. The AP may then become a sharing AP, and it may share the TXOP with other AP(s) in one or multiple MAPC groups in time/frequency/spatial/power domain using schemes such as coordinated TDMA (Co-TDMA), Coordinated NPCA (Co-NPCA), Coordinated Beam Forming (Co-BF), Coordinated Spatial Reuse (Co-SR), Coordinated Restricted Target Wake time (Co-RTWT) etc.
a) The APs may do the non-AP STA selection/grouping 260 again in this stage. The group formed before may be updated. In one method, the APs may coordinate with each other and may down-select the non-AP STAs selected in the non-AP STA Pre-Selection/Grouping step based on the TXOP-level coordination/negotiation. The detailed coordination/negotiation may be MAPC scheme dependent. This step may be skipped for some MAPC schemes.
b) The APs may exchange intended receiving non-AP STA information to each other. This step may be realized by exchange frames between APs at the beginning of the TXOP. This step may be skipped for some MAPC schemes.
c) The APs may exchange necessary MAPC parameters to each other. For example, the parameters used to align the concurrent PPDUs may be exchanged between APs before the MAPC transmission so that the transmissions of the concurrent PPDUs may not interference with each other. For example, the buffer status at each AP side may be exchanged so that APs know the need of the other APs. This step may be skipped for some MAPC schemes.
d) The APs may perform MAPC transmission.

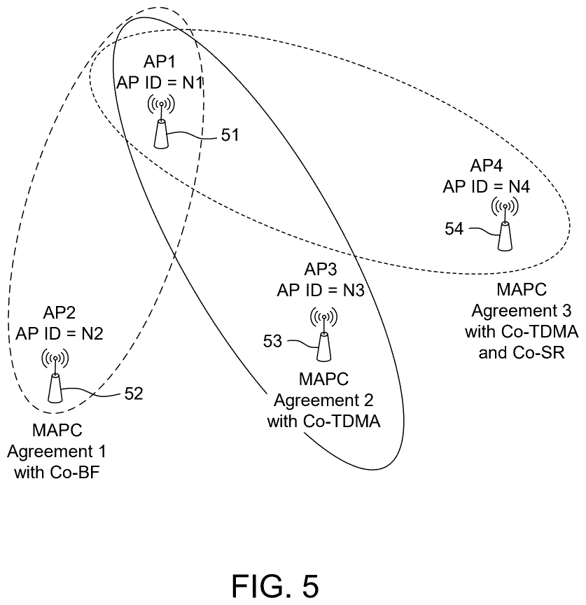

FIG. 5 shows an example that an AP (e.g., AP 1) 51 sets up multiple MAPC agreements with multiple APs 52; 53 and 54. APs 52; 53 and 54 are Overlapping Basic Service Sets (OBSSs) APs with the first AP, AP1 51. In this example, AP1 51 may set up a MAPC agreement with AP2 52 for Co-BF. AP1 51 may set up a MAPC agreement with AP3 53 for Co-TDMA. AP1 51 may set up a MAPC agreement with AP4 54 for both Co-TDMA and Co-SR. AP1 51 may use AP ID N1; AP2 52 may use AP ID N2; AP3 53 may use AP ID N3 and AP4 54 may use AP ID N4. After MAPC negotiation and setups, each AP may announce the MAP coordination agreements in its transmitted frame(s) (e.g., Beacon frame, Probe Response frame, (Re) Association Response frame) to the associated APs. For example, AP1 51 may include the three MAPC agreements in the frame(s). Later, AP1 51 may acquire the wireless medium through CSMA/CA or other channel access scheme. AP1 51 may consider MAPC with other APs and AP1 become a sharing AP. AP1 may perform Co-TDMA with both AP2 52 and AP4 54. AP2 52 and AP4 54 may be the shared AP or polled AP or coordinated AP in this MAPC TXOP.

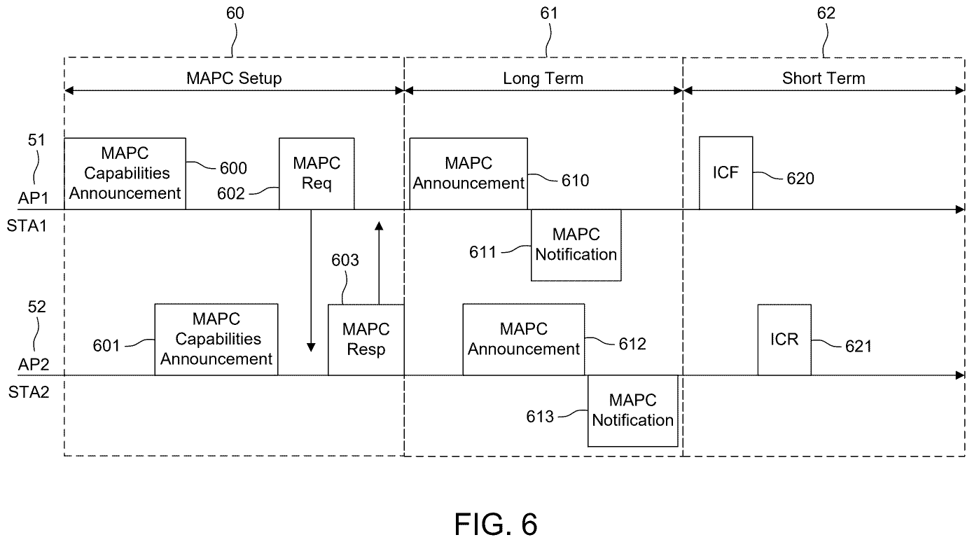

FIG. 6 shows a general procedure or MAPC setup 60, long-term setting 61 and short-term setting 62. AP2 52 performs MAPC setup using MAPC Capabilities Announcement, MAPC Request/Response frame exchanges. In this example, AP1 51 broadcasts a MPAC capabilities announcement frame 600 that is received by AP2 52. In this example, AP2 52 broadcasts a MPAC capabilities announcement frame 601 that is received by AP1 51. Then, in view of MPAC capabilities Announcement 601 received by AP1 51 from AP2 52, the AP1 51 may send a request 602 to the AP2 52. Then, the AP2 52 sends a MAPC response 603 to the AP1 51.

After the setup phase 60, with long-term setup 61, each AP 51 and 52 may transmit MAPC Announcement to its associated non-AP STAs. For example, the AP1 51 may transmit a MPAC announcement 610 to its associated non-AP STAs. The AP1 52 may transmit a MPAC announcement 612 to its associated non-AP STAs. One or more non-AP STAs may respond with a MAPC Notification. For example, in response to MAPC Announcement 610, a non-AP STA associated with AP1 51 may transmit a MPAC notification 611 to its associated AP1 51. For example, in response to MAPC Announcement 612, a non-AP STA associated with AP2 52 may transmit a MPAC notification 613 to its associated AP2 52.

After the long-term setup 62, the APs (e.g., AP1 51 and AP2 52) may perform TXOP level MAPC transmissions 26 as shown as the short-term MAPC 62 scheme in the FIG. 6. In this example, the AP1, 51 may acquire the wireless medium using CSMA/CA or other type of channel access scheme allowed. AP1, 51 may transmit an Initial Control frame (ICF) to announce the start of the TXOP with certain MAPC scheme and check if AP2, 52 may want to participate the MAPC transmission in the TXOP. The AP, 52 may respond with an Initial Control Response frame (ICR) to accept or reject to participate in the MAPC. After this exchange, APs may exchange additional parameters depending on the MAPC scheme. Then APs may start the MAPC transmissions.

Here, the long-term setup is described and include MAPC Announcement, the MAPC Notification which may include MAPC disabling/enabling, MAPC grouping or non-AP STA selection, and MAPC measurement.

MAPC capabilities announcement is described herein.

APs which may be capable to perform coordinated MAP transmission (e.g., any of coordinated spatial reuse (Co-SR), coordinated beamforming (Co-BF), coordinated TDMA (Co-TDMA), coordinated restricted TWT (Co-RTWT), coordinated NPCA (Co-NPCA) etc.) may announce (e.g., transmit information indicating) any of its MAPC related capabilities and operation parameters in one or more frames to its neighboring APs.

In one example, the abovementioned information may be carried in an element and the element may be carried in a management frame (e.g., beacon) and broadcasted by the AP. In one example, the information may be carried in the UHR capabilities element (or UHR+ capabilities element). An exemplary UHR/UHR+ capabilities element is shown in Table 9.

TABLE 9
UHR/UHR+ capabilities element.

| | | | | | | |
|---|---|---|---|---|---|---|
| Element | Length | Element | UHR/UHR+ | UHR/UHR+ | UHR/UHR+ | Supported |
| ID | | ID | MAC | PHY | MAPC | MCS And |
| | | Extension | Capabilities | Capabilities | Capabilities | NSS Set |

The element ID field, length field and element ID extension fields are described in Table 1.

The UHR/UHR+ MAC capabilities field may carry/indicate MAC layer capabilities. The UHR/UHR+ PHY capabilities field may carry/indicate PHY layer capabilities.

The UHR/UHR+ MAPC capabilities field may carry/indicate MAPC related capabilities as shown in Table 10.

TABLE 10
Examples of UHR/UHR+ MAPC capabilities field.

| | | | | | |
|---|---|---|---|---|---|
| Co-BF | Co-SR | Co-RTWT | Co-TDMA | Co-NPCA | AP TB |
| Support | Support | Support | Support | Support | PPDU |
| Buffer | LL Traffic | (Un)Avail- | Maximum | Number | AP ID |
| Status | Report | able AP | Number | of MAPC | |
| Report | Supported | AID List | of MAPC | Groups | |
| Supported | | | Groups | | |
| Co-BF | Co-SR | Co-RTWT | Co-TDMA | Co-NPCA | AP TB |
| Support | Support | Support | Support | Support | PPDU |
| Buffer | LL Traffic | (Un)Avail- | Maximum | Number | Active |
| Status | Report | able AP | Number | of MAPC | AP ID |
| Report | Supported | AID List | of MAPC | Groups | |
| Supported | | | Groups | | |

The Co-BF support subfield may indicate if Co-BF is supported by the AP.

The Co-SR support subfield may indicate if Co-SR is supported by the AP.

The Co-RTWT support subfield may indicate if Co-RTWT is supported by the AP.

The Co-TDMA support subfield may indicate if Co-TDMA is supported by the AP.

The Co-NPCA support subfield may indicate if Co-NPCA is supported by the AP.

The AP TB PPDU subfield may indicate if the AP can transmit a trigger based PPDU (TB PPDU).

The buffer status report supported subfield may indicate if the AP supports to transmit a buffer status report to another AP. In one example, the buffer status report may be an aggregated buffer status among (e.g., all) the active users associated with the AP.

The low latency (LL) traffic report supported subfield may indicate if the AP supports to transmit a LL traffic report to another AP.

The (un) available AP association identifier (AID) list subfield may indicate the available or unavailable AP AID list. An AP association ID (AID) may be unique locally and this field may be used between APs to maintain the uniqueness of the usage of AP AID.

The maximum number of MAPC groups subfield may indicate the upper bound (e.g., maximum) number of MAPC groups the AP may be able to participate.

The number of MAPC groups subfield may indicate the number of MAPC groups the AP may currently be participating.

The active AP ID subfield may indicate the AP ID used by the AP. The subfield may be set to a special value (e.g., zero) to indicate the AP may not have any AP ID assigned.

In on example, one or more fields mentioned above may be carried in another element, such as e.g., UHR operation element.

In one example, the information may be carried in a newly defined element, such as MAPC capabilities element (as shown in Table 11). The element ID field, length field and element ID Extension fields are described in Table 1. The UHR MAPC capabilities field is shown in Table 10.

TABLE 11
MAPC Capabilities element format.

| | | | |
|---|---|---|---|
| Element ID | Length | Element ID | UHR MAPC |
| | | Extension | Capabilities |

In one example, the abovementioned information may be carried in a MAC frame such as any of a management frame, an action frame, a control frame and a data frame. For example, it may be carried in a newly defined MAC frame, e.g., MAP capabilities announcement frame. The frame may (e.g., also) carry additional elements which may define the basic operating parameters of the AP such as the operating channel information. For example, it may carry the operating channel information (OCI) element defined in IEEE P802.11-REVme/D7.0.

In one example, the frame may be carried by non-HT PPDUs and transmitted on the primary channel. In one example, the frame may be carried by non-HT duplicate PPDUs and transmitted repeatedly on every 20 MHz unpunctured subchannels within the AP's operation channel width.

In one example, the frame may carry/indicate security keys for the neighboring APs to detect protected frames.

An example MAPC setup procedure is described herein.

Any of a pair of APs and multiple APs may set up the MAPC transmissions and/or form an MAPC group by exchanging frames between APs. The frame exchanged may be referred to as MAPC request/response frame or other type of any of management frame, action frame, control frame. The frames may carry MAPC related parameters for the MAPC operation. The coordination of the APs may allow an AP to share its acquired resources, such as frequency/time/spatial resources with one or more APs.

In one example, (e.g., all) the APs may be with the same primary channel and the communication between the APs may be carried in a non-HT PPDU or UHR/UHR+ PPDU over the primary channel. In one example, the APs in the MAPC may operate on overlapping subchannels. The APs may have different primary channel, and they may not be able to monitor the beacon frame of each other.

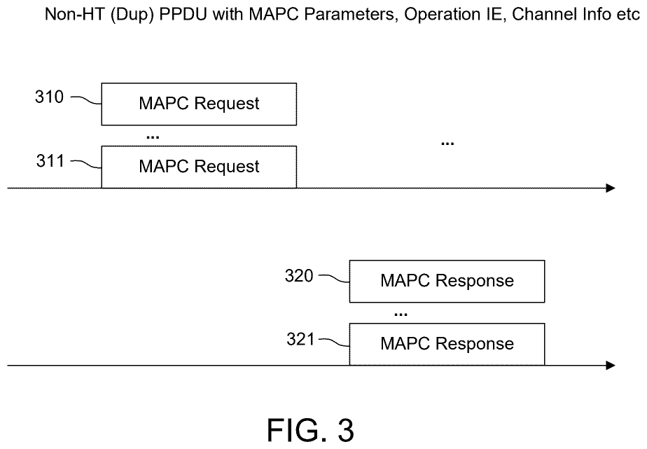

FIG. 3 is a diagram illustrating an example MAPC request/response procedure.

An AP (AP1) which may acquire the wireless medium and may (e.g., intend to) start an MAPC setup may transmit an MAPC request frame 310, 311 which may be individually addressed and carried in any of a non-HT duplicate (Dup) PPDU, a non-HT PPDU, and a UHR/UHR+ PPDU to another (e.g., neighboring) AP (AP2) which have corresponding (e.g., similar) MAPC capabilities. The two MAPC request frames 310, 311 shown at FIG. 3 refer to two duplicate PPDUs (e.g., in frequency domain).

The neighboring AP (AP2) may respond with an individually addressed MAPC response frame 320, 321 carried in any of a non-HT Dup PPDU, a non-HT PPDU and a UHR/UHR+ PPDU to AP1. The two MAPC response frames 320 321 shown at FIG. 3 refer to two duplicate PPDUs (e.g., in frequency domain).

In another example, a first AP (AP1) may transmit the MAPC request frame to one or more neighboring APs (e.g., AP2 and AP3). The intended receiving APs may indicate that they support TB PPDU in the MAPC capabilities announcement.

For example, the first AP (AP1) which may acquire the wireless medium and may (e.g., intend to) start an MAPC setup, may transmit an MAPC request frame carried in any of a non-HT Dup PPDU and a non-HT PPDU to multiple neighboring APs (e.g., AP2, and AP3). In one example, the MAPC request frame may be a type of trigger frame which may allocate resources for the receiving APs to transmit response frames. In another example, the MAPC request frame may be aggregated with a trigger frame. The MAPC request frame may carry any of MAPC parameters and BSS operation parameters and the trigger frame may allocate resource for the receiving APs to transmit response frames.

The neighboring APs (AP2 and AP3) may respond with MAPC response frames carried in TB PPDUs.

If the responding AP accepts the requested MAPC, it may transmit the MAPC response frame including the status code set to success. In one example, if the responding AP accepts the MAPC request, the MAPC response frame may not (e.g., need to) carry any of the MAPC parameters, the MAPC control, and security parameters. The successfully negotiated MAPC may be active until it may be torn down or replaced/updated by a reconfiguration.

In one example, the negotiated MAPC may allow multiple MAPC schemes between any of the pair of APs and the group of APs.

In one example, an AP may successfully negotiate multiple MAPCs with multiple APs or multiple groups of APs through multiple MAPC request/response frame exchanges.

In one example, if the responding AP rejects an MAPC request (e.g., by setting the status code to reject), the APs (any of the initiating AP and the responding AP) may set up the negotiation again by transmitting the MAPC request/response frame at a later time. In one example, if the responding AP rejects the MAPC request, the MAPC response frame may not (e.g., need to) carry any of the MAPC parameters, the MAPC control, and security parameters. The new negotiation may have a new value for the dialog token field.

In one example, a responding AP may reject an MAPC request and may suggest a new set of MAPC parameters. It may transmit an MAPC response frame in response to the MAPC request frame to reject the request (e.g., by setting the status code to reject). Later, the responding AP may acquire the wireless medium and may transmit an MAPC response frame to the initiator AP in an unsolicited way to suggest an alternative set of MAPC parameters (e.g., by setting the status code to “MAPC suggested”). The initiating AP may respond with another MAPC response frame to accept or reject the alternative parameters. In an example, (e.g., all) the MAPC request/response frames exchanged may contain the same value for the dialog token field to indicate the MAPC negotiation.

In one example, a responding AP may reject an MAPC request and may suggest a new set of MAPC parameters. It may transmit an MAPC response frame in response to the MAPC request frame to reject the request and may suggest a new set of parameters (e.g., set the status code field to “MAPC alternative provided”). The initiating AP may respond with another MAPC response frame to accept or reject the alternative parameters. In an example, (e.g., all) the MAPC request/response frames exchanged may contain the same value for the dialog token field to indicate the MAPC negotiation.

AP ID assignment is described herein.

The AP ID may be used to identify an AP in a MAPC transmission. The AP ID may be a shortened identifier (e.g., of a shorter size) compared to the (e.g., full) MAC address to identify an AP. For example, the AP ID (e.g., size, length) may be of eleven or twelve bits, where the (e.g., full) MAC address may be 48 bit long (any number of bits lower than the MAC address size is compatible with embodiments described herein). In one example, the AP ID may be an association ID (AID) assigned/chosen/determined by an AP. A range of AID values may be predefined and reserved for APs. For example, an AP may not assign any values in the range to any associated non-AP STA. An AP may not use any value in the range for other purposes.

The AP ID assignment/selection may be dynamic. For example, the AP may participate to one or more MAPCs. The AP may choose/determine an AP ID for itself. Later, if the AP determines not to participate to any MAPC, it may stop using the AP ID and may release it. Other APs may select to use the AP ID.

The AP ID may be used in any of a control frame (e.g., any of a trigger frame, a null data physical layer protocol data unit announcement (NDPA) frame) and a management frame to indicate that the corresponding user specific information may be meant to (e.g., associated with, directed to) an AP. The AP ID may be unique in the local BSS neighborhood. In one example, an AP may be associated with multiple MAPCs or MAPC groups, and the AP may have one AP ID (e.g., commonly) used in the MAPCs or MAPC groups.

AP ID setting may be performed during the MAPC setup procedure. To provide unique AP ID assignment, the method described herein may be utilized.

The AP ID may be selected from a range of AIDs. The range of AIDs may be predefined. For example, a number (referred to as N) of continuous AID values may be reserved for APs. N may be, for example, 32, 64, or 128 etc.

An AP may monitor the transmission from other APs and maintain an (un) available AP ID list. The list may contain the (un) available AP IDs in the neighborhood of the AP. In one example, the list may be a bitmap with size of N. Each bit in the bitmap may indicate an AP ID value. If the bit is set to one (or zero), it may indicate the corresponding AP ID value may be used/unavailable, otherwise it may be available.

An AP may announce the (un) available AP ID list in its MAPC capabilities field, and/or beacon frame, and/or the MAPC request/response frames. The AP may have an active AP ID subfield included in the MAPC capabilities field and/or another field/element (e.g., UHR operation element) carried in a broadcast frame (e.g., beacon frame or MAPC capabilities announcement frame). The active AP ID subfield may indicate the AP ID currently used by the AP. The subfield may be set to a special value (e.g., zero) to indicate that no AP ID may be assigned.

In one method, on reception of this signaling, a neighboring AP may update its own (un) available AP ID list.

In the MAPC request frame, the initiating AP may carry/include/indicate its (un) available AP ID list as described herein. In one example method (referred to as method 1), if the initiating AP has no active AP ID, the initiating AP may choose/select an available ID for itself based on its (un) available AP ID list and/or the (un) available AP ID list transmitted by the responding AP in the MAPC capabilities field/information element (IE)/frame. If the responding AP has no active AP ID, the initiating AP may choose/select an available ID for (e.g., each of) its responding AP based on its (un) available AP ID list and/or the (un) available AP ID list received from the responding AP in the MAPC capabilities field/IE/frame. After the AP ID selection, the initiating AP and/or responding AP may update its (un) available AP ID list by marking the selected IDs as unavailable and transmit the updated list e.g., in any of the beacon frame, MAPC capabilities announcement frame and other broadcast frames. If the initiating AP has an AP ID, it may include the AP ID in the MAPC request frame. If the responding AP has an AP ID, the initiating AP may acquire the responding AP ID through its MAPC capabilities field carried in MAPC capabilities announcement frame or beacon frame. The initiating AP may include the AP ID of the responding AP in the MAPC request frame.

In one example method (referred to as method 2), if the initiating AP has no active AP ID, the initiating AP may choose/select an available ID for itself based on its (un) available AP ID list and/or the (un) available AP ID list received from the responding AP in the MAPC capabilities field/IE/frame. After the AP ID selection, the initiating AP and/or the responding AP may update its (un) available AP ID list by marking the selected IDs as unavailable and transmit the updated list in any of the beacon frame, a MAPC capabilities announcement frame, and other broadcast frames. If the initiating AP has an AP ID, it may include/indicate the AP ID in the MAPC request frame.

In the MAPC response frame, the responding AP may carry/include/indicate its (un) available AP ID list, as described herein. With method 1, the responding AP may confirm the AP ID assigned by the initiating AP. After the AP ID confirmation, the initiating AP and/or the responding AP may update its (un) available AP ID list by marking the selected IDs as unavailable and transmit the updated list in any of the beacon frame, a MAPC capabilities announcement frame and other broadcast frames. With method 2, if the responding AP has no active AP ID, the responding AP may choose/select an available ID for itself based on its (un) available AP ID list and/or the (un) available AP ID list transmitted by the initiating AP in the MAPC capabilities field/IE/frame. After the AP ID selection, the initiating AP and/or the responding AP may update its (un) available AP ID list by marking the selected IDs as unavailable and transmit the updated list in any of the beacon frame, a MAPC capabilities announcement frame and other broadcast frames. If the responding AP has an AP ID, it may include the AP ID in the MAPC response frame.

After the AP ID assignment/selection, any of the initiating AP and the responding AP may announce their active AP ID in the MAPC capabilities field or another field/element carried in a broadcast frame.

On detection of AP ID collision, e.g., an AP may notice its AP ID may be used in a MAPC or MAPC group it may not participate, or it may receive a AP ID collision report from an associated STA or an AP, the AP may change its AP ID. In one method, the AP may transmit a frame with/indicating an AP ID change announcement. For example, the AP may transmit an AP ID change announcement element which may be carried in a broadcast frame (e.g., any of a beacon frame, a probe response frame, a (re) association response frame etc.). An UHR/UHR+AP may announce an upcoming AP ID change for a period of time (e.g., that may be sufficiently long) for (e.g., all) STAs/APs in one or more MAPC groups, including STAs in power save (PS) mode, to have an opportunity to receive at least one frame carrying an AP ID change announcement element before the AP ID may change.

An example of AP ID change announcement element is provided in Table 12. The element ID field, the length field and the element ID extension field are shown in Table 1.

The AP ID changing countdown field may be set to the number of target beacon transmission times (TBTTs) from current time to the time that the AP sending the AP ID change announcement element may switch to the new AP ID. In one example, the value one may indicate that the switch may occur at the next TBTT (the ensuing beacon frame may advertise in the active AP ID subfield with the new AP ID). The value zero may be reserved. In one example, during the countdown time, the AP may suspend/disable the MAPC operations due to e.g., AP ID collision. TBTT is used in embodiments described herein as time unit. Any other time unit such as microsecond, millisecond, etc. may be applicable to embodiments described herein.

The old AP ID may carry/indicate the old AP ID value so that other APs which may receive this element may know the AP ID that may be used by some neighboring AP.

The new AP ID may carry/indicate the new AP ID value. The AP may choose/select a new AP ID based on its (un) available AP ID list. The AP may (e.g., need to) update its (un) available AP ID list and may carry it in a broadcast frame.

TABLE 12
AP ID change announcement element format.

| | | | | | |
|---|---|---|---|---|---|
| Element | Length | Element ID | AP ID | Old AP | New AP |
| ID | | Extension | Changing | ID | ID |
| | | | Countdown | | |

In one example, the AP ID may be assigned based on BSS color being utilized. For example, there may be a one-to-one mapping (e.g., association) between AP ID and BSS color. In an example, an AP may detect BSS color collision, meaning that it may have AP ID collision, and vice versa. AP ID collision may be avoided based on reusing the BSS color procedures described in IEEE P802.11-REVme/D7.0.

In one example, (e.g., all) APs that may be member of a multiple BSSID set or co-hosted BSSID set may use/share a common AP ID. If this method is used, in the procedure described here below when it is mentioned that an AP has no active AP ID it may mean that (e.g., all) the APs in the multiple BSSID set or co-hosted BSSID set have no active AP ID.

Relative AP ID Assignment is described herein.

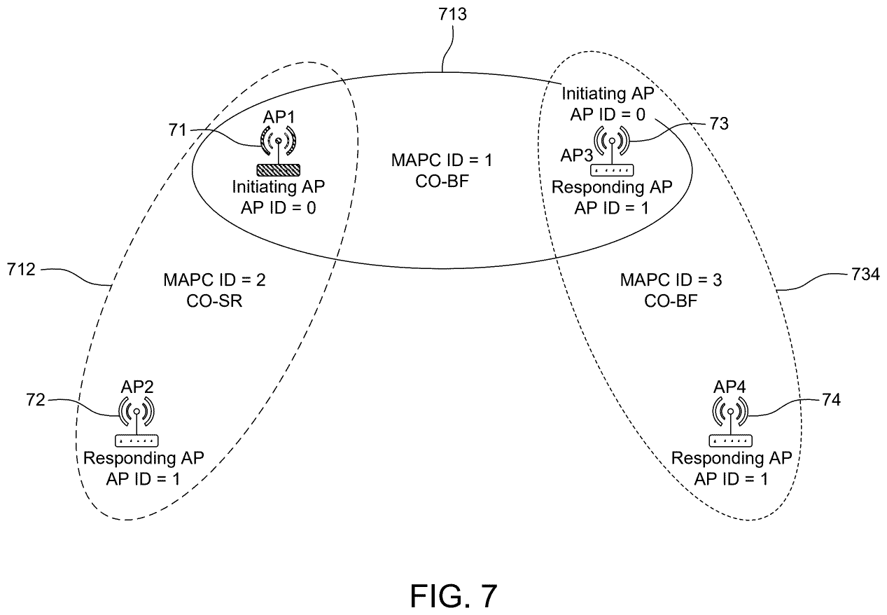

In one embodiment, the AP ID assignment may be relative to each individual MAPC agreement such that the assigned AP IDs may be valid only for a specific MAPC agreement in which this AP ID assignment took place. In one example shown in FIG. 7, three different agreements are identified as MAPC ID 1, MAPC ID 2, and MAPC ID 3 are negotiated between 4 APs (AP1 71, AP2 72, AP3 73, and AP4 74). In the first MAPC agreement (MAPC ID 1) 713, AP1 71 may be the Initiating AP (Sharing AP) and AP3 73 may be the Responding AP (Shared AP) and the negotiated coordinated transmission may be coordinated beamforming (CO-BF). In the second MAPC agreement (MAPC ID 2) 712, AP1 71 may be the Initiating AP (Sharing AP) and AP2 may be the Responding AP (Shared AP) and the negotiated coordinated transmission may be coordinated spatial reuse (Co-SR). In the third MAPC agreement (MAPC ID 3) 734, AP3 73 is the Initiating AP (Sharing AP) and AP4 74 may be the Responding AP (Shared AP) and the negotiated coordinated transmission is CO-BF. APs 72, 73 and 74 are Overlapping Basic Service Set (OBSS) APs with AP1 71. APs 72; 71 and 74 are Overlapping Basic Service Set (OBSS) APs with the AP3 73.

In relative AP ID assignment, the initiating AP 71 may claim AP ID=0 and assign incremental AP ID(s) for the responding AP(s). In particular, the first responding AP 73 may be assigned AP ID=1, the second responding AP 712 may be assigned AP ID=2, and so on and so forth. The MAPC agreement ID together with the AP ID relative to this agreement may uniquely identify the agreement and the APs participating in this agreement. Each AP 71, 72, 73 and 74 supporting MAPC may need to maintain a list of the negotiated agreements (e.g., MAPC ID 1, MAPC ID 2, . . . ) and the AP ID assignment relative to each agreement.

The procedure to complete the AP ID assignment in relative AP ID assignment may be as follows:
1. The initiating AP may send a MAPC Request frame with the MAPC Control field contains the MAPC ID and the assigned Responding AP ID.
2. The responding AP may receive the MAPC Request frame and maintain a list of the MAPC agreements each identified by the assigned MAPC ID
3. The responding AP may then use the assigned AP ID in all MAP transmissions following the agreement identified by the MAPC ID.
4. The responding AP may use the AP ID=0 to identify the initiating AP in the corresponding MAPC agreement.

In one embodiment, the initiating and responding APs may release the AP ID assignment related to a certain MAPC agreement once the agreement is terminated either explicitly through a frame exchange sequence or implicitly following a countdown or an event that is designated to terminate the active MAPC agreements.

In one example, an AP may terminate (e.g., all) the MAPCs and may release its AP ID. The AP may announce/transmit the AP ID releasement in a broadcast frame. For example, the AP may transmit an AP ID release element in a broadcast frame, such as a beacon frame. An UHR/UHR+ AP may announce an upcoming AP ID release for a period of time (e.g., that may be sufficiently long for (e.g., all) STAs/APs in one or more MAPC groups, including STAs in PS mode), to have an opportunity to receive at least one frame carrying an AP ID release element before the AP ID may be released.

The AP ID release element is shown in Table 13.

The example of AP ID change announcement element is given in Table 12. The element ID field, the length field and the element ID extension field are shown in Table 1.

The AP ID release countdown field may be set to the number of TBTTs from current time to the time that the AP sending the AP ID release element may (e.g., fully) stop using the AP ID. In one example, the value one may indicate that the release may occur at the next TBTT (the ensuing beacon frame may advertise in the active AP ID subfield with no AP ID assigned). The value zero may be reserved. In one example, during the countdown time, the AP may continue using the AP ID to provide service. TBTT is used in embodiments described herein as time unit. Any other time unit such as microsecond, millisecond, etc. may be applicable to embodiments described herein.

The released AP ID field may carry/include/indicate the AP ID value to be released by the AP. The AP may (e.g., need to) update its (un) available AP ID list and carry it in a broadcast frame. On reception of this element, other APs may (e.g., need to) update their (un) available AP ID list and broadcast the list.

In an example, this field may be carried in another element/field transmitted in a broadcast frame.

TABLE 13
AP ID release element format.

| | | | | |
|---|---|---|---|---|
| Element ID | Length | Element ID | AP ID Release | Released |
| | | Extension | Countdown | AP ID |

A MAPC request/response action frame is described herein.

In one example, the MAPC request/response frames may comprise action frames with general format. In one example, the MAPC request/response frames may comprise protected UHR action frames with general format as shown in Table 3. In one example, the MAPC request/response frames may comprise UHR action frames with general format as shown in Table 4. An example of (protected) UHR action field values is shown in Table 14. The (protected) UHR action field set to zero may indicate that the frame may be an MAPC request frame and set to one may indicate that the frame may be an MAPC response frame. The field set to two may indicate the teardown of the MAPC. The field set to three may indicate a MAPC reconfiguration request. The field set to four may indicate a MAPC reconfiguration response. In one example, the MAPC request/response/teardown/reconfiguration frames may comprise public action frames. The category field may indicate this may be a public action frame. The public action field values may be set to 61, 62, 63, 64 respectively. The values 61-64 are provided as examples and other values may be applicable to indicate the MAPC request/response/teardown/reconfiguration frames.

TABLE 14
(Protected) UHR action field values.

| Value | Meaning |
|---|---|
| 0 | MAPC Request |
| 1 | MAPC Response |
| 2 | MAPC Teardown |
| 3 | MAPC Reconfiguration Request |
| 4 | MAPC Reconfiguration Response |
| . . . | . . . |

A MAPC request frame is described herein.

The MAPC request frame format is shown in Table 15. The category and (protected) UHR action field (or public action field) are shown in Table 2 and Table 3. The dialog token field may be set to a nonzero value chosen by the initiating AP to identify the request/response transaction.

TABLE 15
MAPC request frame action field format.

| Order | Information |
|---|---|
| 1 | Category |
| 2 | (Protected) UHR Action (or Public |
| | Action) |
| 3 | Dialog Token |
| 4 | MAPC Control |
| 5 | MAPC Parameters |
| 6 | Security Parameters |

The format of the MAPC control field is shown in Table 16. The AP transmitting the MAPC request frame may be referred to herein as the MAPC negotiation initiating AP (e.g., initiating AP). The receiving AP of the MAPC request frame may be referred to herein as the MAPC negotiation responding AP (e.g., responding AP).

The initiating AP ID subfield may indicate the suggested AP ID to identify the initiating AP. The initiating AP may select the AP ID for itself. The AP ID value set in the subfield may not be used to identify any other STAs (including APs and/or non-AP STAs) nearby.

The responding AP ID subfield may indicate the suggested AP ID to identify the responding AP. In the case multiple responding AP may be present, multiple responding AP ID subfield may be present. The responding AP may announce its used or unused AP ID in the MAPC capabilities announcement/IE/frame so that the initiating AP may select an available/unused AP ID value for the responding AP. The AP ID value may not be used to identify any other STAs (including APs and/or non-AP STAs) nearby.

The MAPC ID subfield may indicate the suggested MAPC ID which may be used to identify any of (i) a pair or group of APs (e.g., the MAPC group) and (ii) the negotiated MAP coordination between a pair or group of APs. In one example, the MAPC ID subfield together with e.g., the initiating AP ID, responding AP ID(s) may be used together to identify the MAP coordination negotiated.

In another example, the dialog token field may be present, for example, as the third order in the MAPC request frame. The dialog token together with e.g., the initiating AP ID, responding AP ID(s) may be used together to identify the MAP coordination negotiated.

The Co-BF present subfield may indicate that Co-BF scheme may be allowed, and Co-BF related parameters may be present in the MAPC parameters field.

The Co-SR present subfield may indicate that Co-SR scheme may be allowed, and Co-SR related parameters may be present in the MAPC parameters field. This field may also be used to indicate disallowing legacy SR (Parameterized SR (PSR), and Packet Detection (PD) based SR).

The Co-RTWT present subfield may indicate that Co-RTWT scheme may be allowed, and Co-RTWT related parameters may be present in the MAPC parameters field.

The Co-TDMA present subfield may indicate that Co-TDMA scheme may be allowed, and Co-TDMA related parameters may be present in the MAPC parameters field.

The Co-NPCA present subfield may indicate that Co-NPCA scheme may be allowed and Co-NPCA related parameters may be present in the MAPC parameters field.

The AP TB PPDU allowed subfield may indicate the APs in the MAPC group that may be allowed to transmit TB PPDU.

The buffer status report allowed subfield may indicate the APs in the MAPC group that may be allowed to transmit buffer status report to each other.

The LL traffic report allowed subfield may indicate the APs in the MAPC group that may be allowed to transmit LL traffic report.

The security info present subfield may indicate that security related information (e.g., group keys such as e.g., any of any of group temporal key (GTK), integrity group temporal key (IGTK), and integrity group temporal key (BIGTK) etc.) may be present in the MAPC request frame.

TABLE 16
Exemplary MAPC control field format.

| | | | | | | | |
|---|---|---|---|---|---|---|---|
| Initiating | Responding | MAPC | Co-BF | Co-SR | Co-RTWT | Co-TDMA | Co-NPCA |
| AP ID | AP ID | ID | Present | Present | Present | Present | Present |

| | | | |
|---|---|---|---|
| AP TB | Buffer | LL | Security |
| PPDU | Status | Traffic | Info |
| Allowed | Report | Report | Present |
| | Allowed | Allowed | |

The MAPC parameters field (or element) may contain MAPC scheme parameters. The presence of each subfield may depend on the setting in the MAPC control field. The MAPC parameters field is shown in Table 17.

TABLE 17
MAPC parameters field format.

| | | | | | |
|---|---|---|---|---|---|
| Common | Co-BF | Co-SR | Co-RTWT | Co-TDMA | Co-NPCA |
| Info | Param- | Param- | Param- | Param- | Param- |
| | eters | eters | eters | eters | eters |

The common info subfield may carry information which may be utilized commonly among multiple MAPC schemes. For example, common information may include/indicate any of a (e.g., upper bound, maximum) operation channel width, a primary channel index, punctured channel information, a BSS color and timing information (e.g., which may carry time synchronization function (TSF) related information to allow multiple APs to synchronize for coordinated or joint transmission).

The above-mentioned (common info) parameters may be for (e.g., applicable/directed to) the initiating AP. In one example, the MAPC request frame may (e.g., also) carry the above-mentioned (common info) parameters (e.g., suggested) for the responding AP(s).

The Co-BF parameters subfield may carry Co-BF related parameters, for example including/indicating any of (i) the number of transmit antennas, (ii) the number of receive antennas, (iii) the (e.g., upper bound, maximum) number of spatial streams supported for MAPC data transmission (e.g., including any of the (e.g., upper bound, maximum) number of APs in a Co-BF transmission, the (e.g., upper bound, maximum, total) number of receiving STAs across the APs in a Co-BF transmission, the (e.g., upper bound, maximum) number of spatial streams per receiving STAs in a Co-BF transmission, the (e.g., upper bound, maximum, total) number of spatial streams across receiving STAs in a Co-BF transmission), (iv) the (e.g., upper bound, maximum) number of spatial streams supported for MAPC sounding procedure, (v) the (e.g., upper bound, maximum) number of UHR/UHR+ long training field (LTF) symbols supported for any of transmission, reception, sounding procedure, (vi) supported sounding protocols (e.g., indicating whether the AP supports the sequential sounding protocol and/or the joint sounding protocol).

The above-mentioned (Co-BF) parameters may be for (e.g., applicable/directed to) the initiating AP. In one example, the MAPC request frame may (e.g., also) carry the above-mentioned (Co-BF) parameters (e.g., suggested) for the responding AP(s).

The Co-SR parameters subfield may carry Co-SR related parameters, for example, including/indicating any of (i) a (e.g., maximum and/or minimum) transmit power (e.g., a lower and/or higher transmit power bound) for Co-SR, (ii) a (e.g., maximum and/or minimum) allowed interference level for Co-SR (e.g., the interference may be calculated as the combined received signal power from unintended STAs (e.g., APs and/or non-AP STAs)), (iii) a maximum and/or minimum Signal to interference-plus-noise power ratio (SINR) for Co-SR (The above three parameters (i) to (iii) may be provided at per subchannel level within an OBSS bandwidth. The width of the subchannel may also be included, e.g., in Common Info field), (iv) one or more supported Co-SR modes (for example, Co-SR Mode 1 may be the Co-SR mode allowing concurrent transmission of legacy PPDUs such as UHR+EHT, EHT+UHR or EHT+EHT, and Co-SR Mode 2 may be the Co-SR mode allowing concurrent transmissions of UHR PPDUs). The modes may also include synchronized and unsynchronized in time and frequency concurrent transmissions.

The above-mentioned (Co-SR) parameters may be for (e.g., applicable/directed to) the initiating AP. In one example, the MAPC request frame may (e.g., also) carry the above-mentioned (Co-SR) parameters (e.g., suggested) for the responding AP(s).

The Co-RTWT parameters subfield may carry Co-RTWT related parameters, for example, including/indicating any of (i) one or more (e.g., maximum/minimum) interference threshold (e.g., if the received power of a signal from the responding AP is greater than the interference threshold, the initiating AP may provide RTWT protection for the responding AP; for example, the initiating AP may carry the RTWT elements of the responding AP in its beacon frame so that non-AP STAs in the BSS may terminate their transmission before the start of the RTWT service period (SP)), (ii) one or more prioritized traffic identities (TIDs) in the RTWT (e.g., an RTWT may be used to prioritize the transmission of one or more TIDs; if multiple RTWT elements are associated with the AP, this field may carry the aggregated TIDs prioritized for the RTWT elements), (iii) one or more allowed MAPC schemes within an RTWT SP or a sequence of RTWT SPs.

The above-mentioned (Co-RTWT) parameters may be for (e.g., applicable/directed to) the initiating AP. In one example, the MAPC request frame may (e.g., also) carry the above-mentioned (Co-RTWT) parameters (e.g., suggested) for the responding AP(s).

The Co-TDMA parameters subfield may carry Co-TDMA related parameters, for example, including/indicating any of (i) a TXOP return indication, which may indicate whether the remainder TXOP shared may be to be returned in different scenarios, (ii) Maximum Sharing Duration, which may indicate the maximum allowed sharing duration shared by a sharing AP to one or all shared APs under the MAPC agreement for Co-TDMA.

The above-mentioned (Co-TDMA) parameters may be for (e.g., applicable/directed to) the initiating AP. In one example, the MAPC request frame may (e.g., also) carry the above-mentioned (Co-TDMA) parameters (e.g., suggested) for the responding AP(s).

The Co-NPCA parameters subfield may carry Co-NPCA related parameters, for example, including/indicating any of (i) a NPCA primary channel, (ii) a NPCA switching delay and NPCA switch back delay, (iii) (e.g., minimum, lower bound) duration threshold (e.g., if the duration of the OBSS activity making the primary channel busy is smaller than the threshold, the AP and STAs in the BSS may not switch to the NPCA channel), (iv) (e.g., minimum, lower bound) BSS operating bandwidth for NPCA switching (e.g., an AP may not allow the use of NPCA within its BSS if the BSS operating bandwidth is less than or equal to a certain bandwidth, e.g., 40 MHz or 80 MHz).

The above-mentioned (Co-NPCA) parameters may be for (e.g., applicable/directed to) the initiating AP. In one example, the MAPC request frame may (e.g., also) carry the above-mentioned (Co-NPCA) parameters (e.g., suggested) for the responding AP(s).

The security parameters field may carry security related information, such as group keys (e.g., any GTK, IGTK, and BIGTK etc.) of the initiating AP.

A MAPC response frame is described herein.

The MAPC response frame format is shown in Table 18. The category and (protected) UHR action field (or public action field) are shown in Table 2 and Table 3. The dialog token field may be set to the value of the corresponding MAPC request frame. In one example, the MAPC response frame may be transmitted as an unsolicited response after the responding AP may have rejected an MAPC request. In such example, the dialog token may be set to the value of the MAPC request to indicate that the responding AP may have a set of alternative parameters to suggest for the MAPC operations. In another example, when the MAPC response frame is transmitted as an unsolicited response, the dialog token may be set to zero.

The status code field may indicate the status of the response. The existing values for the status code field are defined in IEEE P802.11-REVme/D7.0 and IEEE P802.11be/D3.0. New values may be added such as:
“MAPC rejected” indicating the MAPC request may be rejected by the responding AP.
“MAPC rejected alternative provided” indicating the MAPC request may be rejected and an alternative schedule may be provided.
“MAPC suggested” indicating the MAPC responding AP may suggest another set of MAPC parameters.

The “success” value was already defined as a possible value for the status code field in IEEE P802.11-REVme/D7.0.

The format of the MAPC control field may be the same as that in the MAPC request frame.

The format of the MAPC parameters field/element maybe the same as that in the MAPC request frame. The parameters carried in the field/element may be for the responding AP (e.g., the AP which may transmit the MAPC response frame) or suggested by the responding AP (e.g., the AP which may transmit the MAPC response frame) e.g., for the AP receiving the response frame.

The security parameters field may carry security related information, such as group keys (e.g., any of GTK, IGTK, BIGTK etc.) of the responding AP (e.g., the AP which may transmit the MAPC response frame).

In one example, the presence of any of the MAPC control field, the MAPC parameters field and the security parameters field may depend on the status code. For example, when the status code is set to accept and/or reject, one or more above-mentioned fields may not be present.

TABLE 18
MAPC response frame action field format.

| Order | Information |
|---|---|
| 1 | Category |
| 2 | (Protected) UHR Action (or Public |
| | Action) |
| 3 | Status Code |
| 4 | MAPC Control |
| 5 | MAPC Parameters |
| 6 | Security Parameters |

MAPC teardown is described herein.

A MAPC teardown frame may be sent by an AP to request the tear down of an existing MAPC agreement that may have been negotiated with a peer AP or a group of APs in a unicast frame or multicast/broadcast frame. The AP may transmit the MAPC teardown frame to its peer AP (or a group of APs or (e.g., all) the STAs in the neighborhood) to indicate that the negotiated MAPC may be terminated or will be terminated. In an example, the peer AP (or a group of APs) may respond with an acknowledgement frame to confirm the termination. In an example, the peer AP (or a group of APs) may respond with a MAPC teardown frame to confirm the termination. In an example, the peer AP may not (e.g., need to) respond.

The action field of the MAPC teardown frame may contain the information shown in Table 19.

TABLE 19
MAPC teardown Action field format.

| Order | Information |
|---|---|
| 1 | Category |
| 2 | (Protected) UHR Action (Public |
| | Action) |
| 3 | MAPC Teardown Countdown |

The category and (protected) UHR action field (or public action) are shown in Table 2 and Table 3.

In one example, an AP may use (e.g., need) a period of time before it may (e.g., fully) tear down the MAPC. For example, it may (e.g., need to) complete the negotiated MAPC transmissions before the termination. In that case, a MAPC teardown countdown field may be carried in the MAPC teardown action field. The MAPC teardown countdown field may be set to the number of TBTTs from current time to the time that the AP sending the MAPC teardown action frame may (e.g., fully) terminate the MAPC. In one example, the value one may indicate that the termination may occur at the next TBTT (that may ensure that the beacon frame may advertise the correct MAPC information to its associated STAs). In one example, the value zero may be reserved (e.g., meaning that the AP may not be able to tear down the MAPC in the current beacon interval). In one example, during the countdown time, the AP may continue serving the negotiated MAPC. In one example, the MAPC teardown frame may be used to terminate (e.g., all) the MAPC schemes negotiated with the peer AP (or a group of APs). In one example, one or more agreed MAPC schemes may be terminated. In this case, the MAPC scheme field may be explicitly carried/indicated by the MAPC teardown frame to explicitly indicate the one or more MAPC schemes may be torn down. In one example, MAPC ID(s) and/or AP ID(s) may be included in the MAPC teardown action frame to terminate a particular MAPC ID (or a group of MAPC IDs) associated with a particular AP ID (or a group of AP IDs). In one example, if the MAPC agreement to be torn down is the only active MAPC agreement for the AP, the AP may implicitly use the teardown frame to indicate the release of the AP ID. In one example, the AP may use one MAPC teardown action frame to terminate (e.g., all) the negotiated MAPC agreements. In one example, e.g., all) MAPC field and/or AP ID release field may be included in the MAPC teardown action frame to indicate that (e.g., all) the MAPC agreements negotiated with the AP may be torn down and/or the AP ID may be released after the MAPC agreement torn down. TBTT is used in embodiments described herein as time unit. Any other time unit such as microsecond, millisecond, etc. may be applicable to embodiments described herein.

MAPC reconfiguration is described herein.

MAPC setup parameters may be changed based on the MAPC teardown and setup procedure, which may imply some overhead.

MAPC reconfiguration procedure provides a dynamic way for APs to modify their MAPC parameters without going through the (e.g., more expensive) MAPC teardown and re-setup procedure. The MAPC reconfiguration may allow APs to add or remove one or more MAPC schemes which may have been set up originally. The MAPC reconfiguration may allow APs to modify the operation parameters and MAPC parameters. The MAPC reconfiguration may allow the MAPC group to add or remove one or more participating APs.

A pair of APs or a group of APs may use MAPC reconfiguration request/response frame exchanges to modify or update one or more MAPC related settings. The MAPC reconfiguration procedure may be similar to the MAPC setup procedure using MAPC request/response frame. A difference may be that the MAPC reconfiguration request/response frame may carry a part of the information contained in the MAPC request/response frame.

MAPC Enabling and Disabling is described herein.

There may be two sets of MAPC enabling and disabling signaling:
BSS level MAPC enabling and disabling: an AP may advertise it may enable/disable the one or more MAPC schemes to its associated STAs and/or APs in the MAPC group. Note, BSS level the MAPC enabling/disabling procedure may not change or modify the negotiated/agreed MAPC parameters.
MAPC enabling and disabling between AP and non-AP STAs: a non-AP STA which is capable of one or more MAPC schemes may indicate it enables/disables the MAPC scheme to its associated AP. Details is disclosed in Section 2.2.8

BSS Level MAPC disabling/enabling is described herein.

An AP which may have successfully negotiated one or more MAPCs with one or more MAPC schemes (e.g., any of Co-BF, Co-SR, Co-RTWT, Co-TDMA, Co-NPCA) may disable one or more MAPC schemes. The AP may re-enable the disabled MAPC schemes at a later point in time.

In one example, the disabling/enabling indication may be carried in an element/field in a broadcast frame. For example, in the UHR/UHR+ operation element, any of following fields may be added: (i) Co-BF enabling/disabling, (ii) Co-SR enabling/disabling, (iii) Co-RTWT enabling/disabling, (iv) Co-TDMA enabling/disabling, and (v) Co-NPCA enabling/disabling.

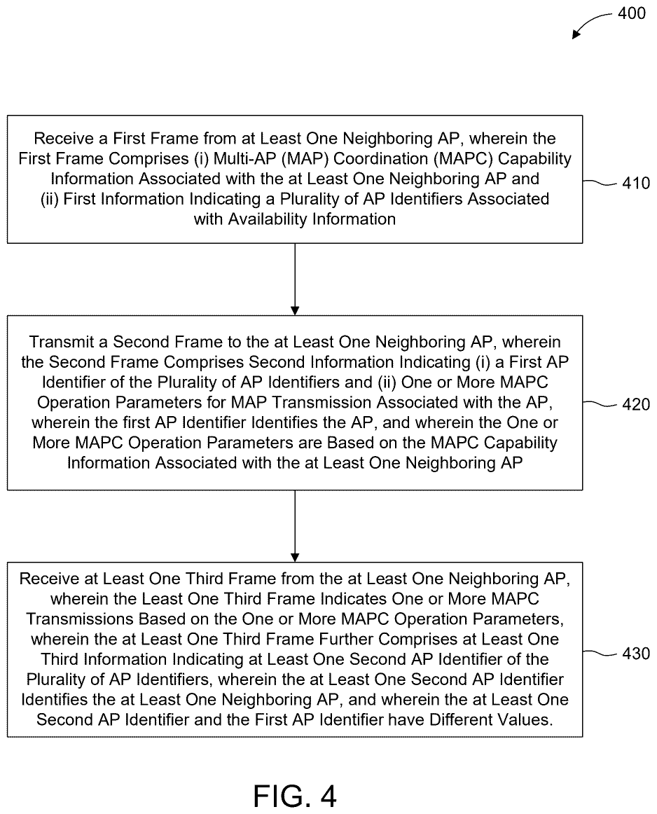

FIG. 4 is a diagram illustrating an example method 400 for MAP coordinated setup, implemented in an AP. The AP may include circuitry including a transmitter, a receiver, a processor, and memory. The AP may be configured to carry out the method 400. As shown at 410, the method 400 may include receiving a first frame from at least one neighboring AP. In various embodiments, the first frame may comprise (i) multi-AP (MAP) coordination (MAPC) capability information associated with the at least one neighboring AP and (ii) first information indicating a plurality of AP identifiers associated with availability information. As shown at 420, the method 400 may include transmitting a second frame to the at least one neighboring AP. In various embodiments, the second frame may comprise second information indicating (i) a first AP identifier of the plurality of AP identifiers and (ii) one or more MAPC operation parameters for MAP transmission associated with the AP. In various embodiments, the first AP identifier may identify the AP. In various embodiments, the one or more MAPC operation parameters may be based on the MAPC capability information associated with the at least one neighboring AP. As shown at 430, the method 400 may include receiving at least one third frame from the at least one neighboring AP. In various embodiments, the least one third frame may indicate one or more MAPC transmissions based on the one or more MAPC operation parameters. In various embodiments, the at least one third frame may further comprise at least one third information indicating at least one second AP identifier of the plurality of AP identifiers. In various embodiments, the at least one second AP identifier may identify the at least one neighboring AP. In various embodiments, wherein the at least one second AP identifier and the first AP identifier may have different values.

In various embodiments, the method 400 may include forming a MAPC group with the at least one neighboring AP based on the at least one third information indicating a success status.

In various embodiments, any of the second information and the at least one third information may indicate a MAPC identifier to be used to identify a negotiated MAPC between the AP and the at least one neighboring AP.

In various embodiments, the MAPC capability information may indicate a capability of the at least one neighboring AP to perform any of coordinated spatial reuse transmissions, coordinated beamforming transmissions, coordinated time division multiple access transmissions, coordinated restricted target wake time transmissions, and coordinated non primary channel access.

In various embodiments, the one or more MAPC operation parameters for MAP transmission associated with the AP may further be based on a MAPC capability of the AP.

In various embodiments, the MAPC capability may comprise a capability of the AP to perform any of coordinated spatial reuse transmissions, coordinated beamforming transmissions, coordinated time division multiple access transmissions, coordinated restricted target wake time transmissions, and coordinated non primary channel access.

In various embodiments, the plurality of AP identifiers associated with availability information may comprise a list of available AP identifiers.

In various embodiments, the at least one second AP identifier and the first AP identifier may have a shorter size relative to a medium access control (MAC) address.

In various embodiments, the second information indicating the first AP identifier may further indicate that the at least one third frame may be to be sent to the AP in response to the second frame.

In various embodiments, the at least one second AP identifier and the first AP identifier may be used to identify respectively the at least one neighboring AP and the AP in MAPC transmissions.

In various embodiments, the one or more MAPC operation parameters may indicate any of an operation channel width, a primary channel index, punctured channel information, a basic service set color and timing information.

In various embodiments, the one or more MAPC operation parameters may comprise any of one or more coordinated spatial reuse parameters, one or more coordinated beamforming parameters, one or more coordinated time division multiple access parameters, one or more coordinated restricted target wake time parameters, and one or more coordinated non primary channel access parameters.

In various embodiments, the one or more coordinated spatial reuse parameters may indicate any of a lower transmit power bound, an upper transmit power bound, one or more allowed interference levels, and one or more supported coordinated spatial reuse modes.

In various embodiments, the one or more coordinated beamforming parameters may indicate any of a number of transmit antenna, a number of receive antenna, a number of spatial streams supported for MAPC data transmission, a number of spatial streams supported for MAPC sounding, and one or more supported sounding protocols.

In various embodiments, the one or more coordinated non primary channel access parameters may indicate any of a primary channel, a non-primary channel access switching delay, non-primary channel access switching back delay, a duration threshold, a basic service set operating bandwidth for non-primary channel access switching.

In various embodiments, the at least one neighboring AP may comprise at least one overlapping basic service set AP

In various embodiments, the first frame may be an announcement frame.

In various embodiments, the second frame may be a request frame.

In various embodiments, the at least one third frame may be at least one response frame.

An MAPC Announcement is described herein.

An AP may need to announce its negotiated MAPCs to its associated non-AP STAs. In one method, the announcement may be carried in a MAPC element and transmitted in a broadcast frame (e.g., a management frame), such as a Beacon frame, a Probe Response frame, a (Re) Association Response frame.

In one method, the MAPC element may be carried in a MAPC Announcement frame which is broadcast to all associated STAs or associated UHR/UHR+ STAs. The MAPC element may not be carried in a Beacon frame. The MAPC Announcement frame may be transmitted after the Beacon frame. The Beacon frame may carry an indication to indicate if the MAPC element may carry updated information or critically updated information. Or the Beacon frame may carry a MAPC Announcement Version field where with updated information carried in the MAPC element, the MAPC Announcement Version field may be set to a new value. An associated UHR/UHR+ STA which had received the previous MAPC Announcement frame may check the indication in Beacon frame and determine whether it needs to decode/monitor the upcoming MAPC Announcement frame. UHR STAs which missed previous MAPC Announcement may still need to monitor even though the indication shows no update. A pre-UHR STA may not need to check the MAPC Announcement frame. The procedure is shown in FIG. 6.

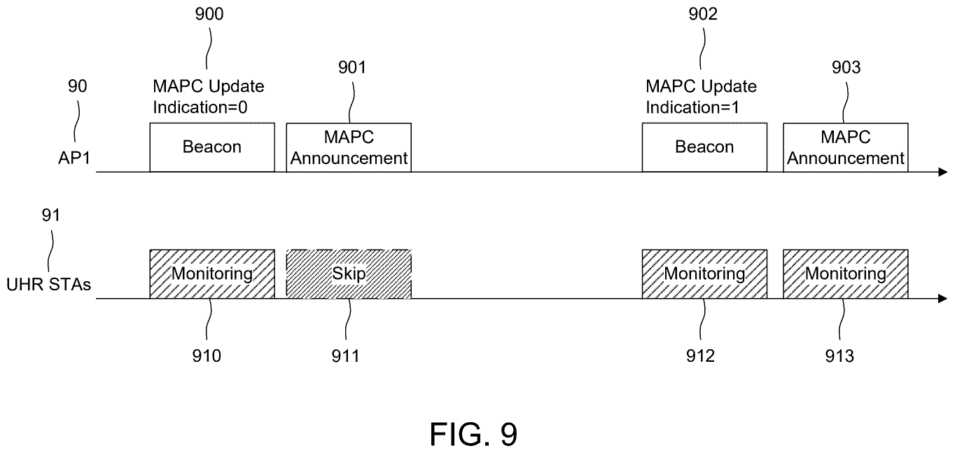

FIG. 9 illustrates that MAPC element may be carried in the MAPC Announcement frame. An MAPC Update Indication field is carried in the Beacon frame to indicate whether the following MAPC Announcement frame carries the updated MAPC element. A UHR STA may determine whether it needs to monitor the MAPC Announcement frame based on an indication in the MAPC Announcement frame.

An MAPC Announcement frame may be an UHR (Protected) Action frame, or a Public Action frame as shown in Table 20. The Category and (Protected) UHR Action field (or Public Action field) are defined in description of general action frame format. The Dialog Token field is a set to a nonzero value chosen by the initiating AP to identify an MAPC Announcement transaction. In one method, the MAPC Announcement frame may be carried in non-HT (Dup) PPDUs or UHR/UHR+ PPDUs.

TABLE 20
MAPC Announcement frame action field format.

| Order | Information |
|---|---|
| 1 | Category |
| 2 | (Protected) UHR Action (or Public |
| | Action) |
| 3 | Dialog Token |
| 4 | MAPC element |

An exemplary format of the MAPC element is given in Table 21. The Element ID field, Length field and Element ID Extension fields are described in view of Table 5 description.

TABLE 21
MAPC element format.

| | | | | |
|---|---|---|---|---|
| Element ID | Length | Element ID | Common | Per MAPC |
| | | Extension | Info | Info |

A Common Info field may carry the common information for all the negotiated MAPC operations. A Common Info field format is given in Table 22:
AP ID field may indicate an AP identifier of the AP which transmits the MAPC element.
TB PPDU Allowed field may indicate if the AP which transmits the MAPC element may transmit TB PPDU if polled by another AP. Or the TB PPDU Allowed field may indicate TB PPDU is allowed to transmit by an AP in the MAP coordination schemes.
Buffer Status Report Allowed field may indicate the AP which transmits the MAPC element may transmit buffer status report to each other. Or the Buffer Status Report Allowed field may indicate the APs which set up the MAPC agreements with the transmitting AP may transmit buffer status report to each other.
LL Traffic Report Allowed field may indicate the AP which transmits the MAPC element may transmit LL traffic report to other APs. Or the LL Traffic Report Allowed field may indicate the APs which set up the MAPC agreements with the transmitting AP may transmit LL traffic report to each other.
The Critical Changes field may indicate whether the MAPC element may contain critical changes from the MAPC element previously transmitted. Examples of the critical changes may be adding a new MAPC agreement with a peer AP (or a peer group of APs); removing an existing MAPC with a peer AP (or a peer group of APs); adding/removing one or more MAPC schemes from an existing MAPC agreement; operation parameter changes from an AP in a MAPC agreement etc.
Number of Per MAPC Info field may indicate the number (or size/length) of Per MAPC Info fields followed Common Info field. In one method, the Per MAPC Info field may be replaced by Per MAPC AP Info field. And thus, the Number of Per MAPC Info field may be replaced by Number of Per MAPC AP Info field. Here the Per MAPC Info field carries information of a MAPC agreement. If the MAPC agreement may have multiple APs involved, then the Per MAPC Info field may carry information regarding the APs. The Per MAPC AP Info field may carry information of an AP which may have one or more MAPC agreements with the transmitting AP. If the AP has multiple MAPC agreements with the AP, then the Per MAPC Info field may carry information of the MAPC agreements.

TABLE 22
Common Info field format.

| | | | | | |
|---|---|---|---|---|---|
| AP ID | TB PPDU | Buffer Status | LL Traffic | Critical | Number of Per MAPC |
| | Allowed | Report | Report | Changes | Info fields |
| | | Allowed | Allowed | | |

One or more Per MAPC Info fields may follow the Common Info field. Each Per MAPC Info field may carry information of an MAPC agreement with negotiated with the AP. The Per MAPC Info field format is given in Table 23:
MAPC AP ID field may indicate the AP ID of the AP which set up the MAPC agreement with the AP. In the case that a MAPC agreement may involve more than two APs, more than one MAPC AP ID fields may present.
MAPC ID field may indicate the identifier of the MAPC agreement. Or the MAPC ID field may indicate the group of APs which establish the MAPC agreement.
MAPC AP MAC Address may indicate the MAC address of the AP which set up the MAPC agreement with the AP. In the case that a MAPC agreement may involve more than two APs, more than one MAPC AP MAC Address fields may present.
Type field may indicate the type of the Per MAPC Info field. For example, it may indicate the list of elements included in the MAPC AP Profile. For example, it may be set to basic to indicate a predefined basic set of elements are included in the MAPC AP Profile. It may be set to medium/high/full to indicate a different set of predefined elements included in the MAPC AP Profile. In one method, the sets may be nested, e.g., the elements carried in the basic type may be carried in the medium/high/full types. In one method, BSS Color may be included for all the types. In an alternative method, the Type field may indicate the usage of the MAPC element, e.g., whether the MAPC element is carried in the Beacon frame, the Probe Request/Response frame, the (Re) Association Request/Response frame, the MAPC Reconfiguration frame etc.
MAPC AP Profile: this may be a sub-element which may contain a list of elements for the MAPC AP identified by the MAPC AP ID. For example, the list of elements may include Transmit Power Envelope, Supported Operating Classes, HT Capabilities, HT Operation, VHT Capabilities, VHT Operation, HE Capabilities, HE Operation, EHT Capabilities, EHT Operation, UHR Capabilities, UHR Operation, HE 6 GHz Band Capabilities, Spatial Reuse Parameter Set, Max Channel Switch Time, Quiet, Quiet Channel, Multiple BSSID Configuration, BSS Color Change Announcement etc. In one method, information about the Beacon transmission be included in the MAPC AP Profile. For example, the transmit power of the Beacon frame, the expected transmit time of the next Beacon frame, Beacon Interval etc. In one method, not all elements are present. In one method, the presence of the elements may depend on the Type field.
MAPC Control field may carry control information of the MAPC agreement e.g. schemes that are present or allowed (e.g. Boolean value=1) or not (e.g. Boolean value=0) as shown in Table 24. The Co-BF Present field may indicate if the Co-BF is allowed in the MAPC agreement and whether the Co-BF parameters are carried in the MAPC Parameters field. The Co-SR Present field may indicate if the Co-SR is allowed in the MAPC agreement and whether the Co-SR parameters are carried in the MAPC Parameters field. The Co-RTWT Present field may indicate if the Co-RTWT is allowed in the MAPC agreement and whether the Co-RTWT parameters are carried in the MAPC Parameters field. The Co-TDMA Present field may indicate if the Co-TDMA is allowed in the MAPC agreement and whether the Co-TDMA parameters are carried in the MAPC Parameters field. The Co-NPCA Present field may indicate if the Co-NPCA is allowed in the MAPC agreement and whether the Co-NPCA parameters are carried in the MAPC Parameters field.
MAPC Parameters field may carry the MAPC parameters as shown in Table 25. In particular, the MAPC parameters field may carry parameters associated, each, with different schemes. The presence of each field may depend on the setting of the MAPC Control field. The parameters carried may be the parameters negotiated and agreed for the MAPC transmissions under the MAPC agreement. And/or the parameters carried may be the parameters used by the AP identified by the MAPC AP ID field.

In one method, the Per MAPC Info field may be replaced by Per MAPC AP Info field. Each Per MAPC AP Info field may carry information regarding one coordinated AP which may have one or more MAPC agreements with the transmitting AP. The content of the Per MAPC may be the same as mentioned above.

TABLE 23
Per MAPC Info field format.

| | | | | | | |
|---|---|---|---|---|---|---|
| MAPC | MAPC | MAPC | Type | MAPC | MAPC | MAPC |
| AP ID | ID | AP MAC | | AP Profile | Control | Parameters |
| | | Address | | | | |

TABLE 24
MAPC Control field format.

| | | | | |
|---|---|---|---|---|
| Co-BF | Co-SR | Co-RTWT | Co-TDMA | Co-NPCA |
| Present | Present | Present | Present | Present |

TABLE 25
MAPC Parameters field format.

| | | | | |
|---|---|---|---|---|
| Co-BF | Co-SR | Co-RTWT | Co-TDMA | Co-NPCA |
| Parameters | Parameters | Parameters | Parameters | Parameters |

The Co-BF Parameters subfield may carry Co-BF related parameters. For example, it may carry.
The number of transmit antennas of the AP identified by the MAPC AP ID field.
The number of received antennas of the AP identified by the MAPC AP ID field.
The maximum number of spatial streams supported for Co-BF data transmission negotiated in the MAPC agreement.
   Maximum number of APs in a Co-BF transmission
   Maximum total number of receiving STAs across the APs in a Co-BF transmission
   Maximum number of spatial streams per receiving STAs in a Co-BF transmission
   Maximum total number of spatial streams across receiving STAs in a Co-BF transmission.
The supported co-BF sounding procedure. There are two Co-BF sounding procedures defined, the UHR TB sequential NDP sounding sequence and the UHR TB joint NDP sounding sequence. This field may indicate if the MAPC agreement supports either one or both or null of them.
The maximum number of spatial streams supported by the AP identified by the MAPC AP ID field for MAPC sounding procedure.
The maximum number of UHR/UHR+ LTF symbols supported by the Co-BF agreement for transmission, reception, sounding procedure.

Co-SR Parameters: this subfield may carry Co-SR related parameters. For example, it may carry
The maximum and/or minimum transmit power of the AP identified by the MAPC AP ID field for Co-SR. And/or the maximum and/or minimum transmit power of the agreed Co-SR scheme in the MAPC agreement.
The maximum and/or minimum allowed interference level of the AP identified by the MAPC AP ID field. And/or the maximum and/or minimum allowed interference level for Co-SR scheme negotiated in the MAPC agreement. The interference may be calculated as the combined received signal power from unintended STAs (e.g., APs and/or non-AP STAs).
The maximum and/or minimum Signal to interference-plus-noise power ratio (SINR) allowed for the AP identified by the MAPC AP ID field. And/or the maximum and/or minimum SINR allowed for Co-SR scheme negotiated in the MAPC agreement.
Note: The above three parameters may be provided at per subchannel level within an OBSS bandwidth. The width of the subchannel may also be included, e.g., in Common Info field
Supported Co-SR modes for the negotiated Co-SR scheme. For example, Co-SR Mode 1 is the Co-SR mode which allows concurrent transmission of legacy PPDUs such as UHR+EHT, EHT+UHR or EHT+EHT. Co-SR Mode 2 is the Co-SR mode which allows concurrent transmissions of UHR PPDUs. The modes may also include synchronized and synchronized in time and frequency concurrent transmissions.

Co-RTWT Parameters: this subfield may carry Co-RTWT related parameters. For example, it may carry.
The maximum/minimum interference threshold for the AP identified by the MAPC AP ID or the Co-RTWT scheme: if the received power of a signal from an AP is greater than the interference threshold, the other AP(s) may provide RTWT protection for the AP. For example, the AP1 and AP2 may have the MAPC agreement with Co-RTWT. AP1 may carry the RTWT elements of the AP2 in its Beacon frame so that applicable non-AP STAs in AP1's BSS may terminate their transmission before the start of the RTWT service period (SP) if AP1 detects the transmission from AP2 is greater than the threshold and verse visa.
Prioritized TIDs in the RTWT: an RTWT may be used to prioritize the transmission of one or more TIDs. If multiple RTWT elements are associated with the AP, this field may carry the aggregated TIDs prioritized for the RTWT elements.
Allowed MAPC schemes within an RTWT SP or a sequence of RTWT SPs: this field may provide a list of allowed MAPC schemes for the overlapping RTWTs. Here the overlapping RTWT may refer to TWT service period(s) from multiple APs that negotiated the MAPC agreement may overlap in time and/or frequency.

Co-TDMA Parameters: this subfield may carry Co-TDMA related parameters. For example, it may carry
TXOP Return Indication: this subfield may indicate whether the remainder TXOP shared shall be returned in different scenarios.
Maximum Sharing Duration: this subfield may indicate the maximum allowed sharing duration shared by a sharing AP to one or all shared APs under the MAPC agreement for Co-TDMA.

Co-NPCA Parameters: this subfield may carry Co-NPCA related parameters. For example, it may carry.
NPCA Primary channel of the AP identified by the MAPC AP ID field.
NPCA switching delay and NPCA switch back delay of the AP identified by the MAPC AP ID field.
Minimum Duration Threshold of the AP identified by the MAPC AP ID field: if the duration of the OBSS activity that makes the primary channel busy is smaller than the threshold, the AP and STAs in the BSS may not switch to the NPCA channel.
Minimum BSS operating bandwidth of the AP identified by the MAPC AP ID field for NPCA switching: An AP shall not allow the use of NPCA within its BSS if the BSS operating bandwidth is less than or equal to a certain bandwidth, e.g., 40 MHz or 80 MHz.

In one method, the APs under MAPC agreements may fix their transmit power for Beacon frame. They may exchange this information for the MAPC setup. An AP may need to include the coordinated AP transmit power of Beacon frame in its MAPC announcement. In this way, the potential MAPC recipient non-AP STAs may monitor the Beacon frame transmissions from the coordinated APs and estimate the pathloss and/or interference level. These measurements could be used for non-AP STA pre-selection for some MAPC schemes, such as Co-SR.

Non-AP STA Behaviors are disclosed herein.

A non-AP STA may report its MAPC capabilities in a MAPC Capabilities element or a UHR Capabilities element to the AP using Probe Request frame, or (Re) Association Request frame or other type of frames.

The non-AP STA which is capable of one or more MAPC schemes may notify its AP its intention to participate one or more MAPC schemes and/or with one or more neighboring APs identified by the MAPC announcement transmitted by its associated AP. The non-AP STA may use the MAPC notification to enable/disable one or more MAPC schemes. The non-AP STA may use the MAPC notification to enable/disable MAP coordination with one or more APs identified by its associated AP in the MAPC Announcement. For some MAPC schemes (e.g., Co-BF, Co-SR), the non-AP STA may use the MAPC notification to report one or more measurements for the AP to arrange its MAPC transmission or sounding procedure. In an embodiment, the STA is configured to determine one or more received signal characteristics from the first AP and the one or more second APs and to transmit, to the first AP, the determined one of more received signal characteristics based on the one or more MAP coordination schemes indicated in a second frame. For example, determining one or more signal characteristics may include measurement of one or more received signal characteristics from the first AP and the one of more second APs. For example, the one or more received signal characteristics is associated with one or more MAP coordination schemes indicated in the second frame. For example, the non-AP STA may report the SINR or SNR or RSSI or pathloss measurement based on the received signal from the APs which provide Co-BF and/or Co-SR with its associated AP. In one example, the measurements may be based on the Beacon frame transmitted by the APs which provide Co-BF and/or Co-SR with its associated AP. In one example, the measurements may be based on the sounding frame transmitted by the APs which provide Co-BF and/or Co-SR with its associated AP. In one method, the Notification and/or the measurement may be carried in management frames, such as Probe Request frames, (Re) Association Request frames etc. In one method, the abovementioned information may be carried separately in different frames. For example, the MAPC scheme enabling/disabling may be carried in a special MAC frame or a field in MAC header. The MAPC related measurement may be carried in another MAC frame or a field in MAC header.

In one method, the notification may be carried in a MAC frame, e.g., a MAPC Notification frame.

In one method, the notification may be carried in a Control field in the MAC header.

A Procedure and Signaling of MAPC Notification Transmission is described herein.

On reception of the MAPC Announcement transmitted by its associated AP, a non-AP STA may transmit a MAPC Notification to its AP to indicate its intention to participate one or more MAPC schemes and/or with one or more neighboring APs.

The exemplary procedures of transmitting MAPC Notification are shown in FIG. 5. Two procedures are shown in the figure: the unsolicited scheme and the solicited schemes.

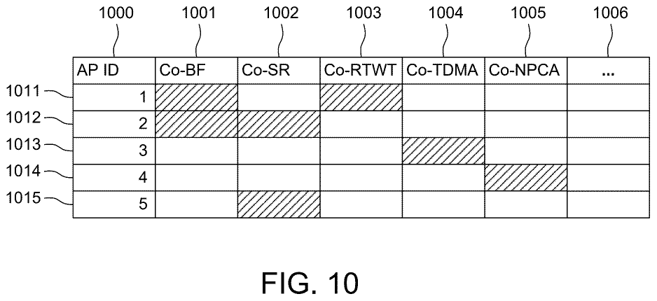

With unsolicited scheme, a non-AP STA (e.g., an UHR/UHR+ STA) may
A non-AP STA may detect a Beacon frame which carries a MAPC element or a MAPC Announcement frame. The STA may notice all the MAPC agreements and MAPC schemes its associated AP may operate. For example, based on the information carried by the MAPC element, the STA may abstract the MAPC scheme table as shown in FIG. 10. In this example, the associated AP may coordinate with AP 1 1011 to AP 5 1015 and provide several MAPC services. With AP 1 1011, they may provide Co-BF and Co-RTWT. With AP 2 1012, they may provide Co-BF and Co-SR. With AP 3 1013, they may provide Co-TDMA. With AP 4 1014, they may provide Co-NPCA. With AP 5 1015, they may provide Co-SR.
The non-AP STA may have MAPC capabilities for one or more MAPC schemes and/or the non-AP STA may determine to participate one or more MAPC agreements and/or with one or more APs identified by the MAPC AP IDs in the MAPC element. It acquires the wireless medium through a WiFi channel access scheme (e.g., CSMA/CA) and transmit a MAPC Notification to its AP. The MAPC Notification may be carried in a MAC frame such as MAPC Notification frame or a control field in the MAC header or with other frame.
In one method, the AP may not respond to the MAPC Notification. In one method, the AP may respond to the MAPC Notification. In one method, the response may be an acknowledgment frame. In one method, the response may be a MAPC Notification carried in a frame or MAC header.
The other non-AP STAs may do the same thing.

With solicited scheme, a non-AP STA 91 (e.g., an UHR/UHR+ STA) and AP1 90 may perform the actions as shown in FIG. 9.

A non-AP STA 91 may detect Beacon frames 900 and 902 sent by an associated AP 90 and which MAPC Update indication field (set to 0 in this example) and, which is followed by a MAPC Announcement frame 901 or 903 which carries a MAPC element. In one method, the MAPC Update Indication field may indicate if the MAPC element carried in the following MAPC Announcement frame may carry updated information or critically updated information. In one method, the MAPC Update Indication field may indicate if the MAPC element carried in the following MAPC Announcement frame may carry updated information or critically updated information for one or more MAPC agreements or schemes. For example, the field may be in the format of a bitmap where each bit may represent one MAPC agreement or scheme. The bit may be set to 0 (or 1) to indicate the MAPC agreement or scheme has not been critically updated. During monitoring 910, the STA 91 may notice no critical update for the MAPC agreements or schemes (since the MAPC Update Indication field is 0), or no critical update for the MAPC agreement(s) or scheme(s) the STA 91 is involved (since the MAPC Update Indication field indicates the corresponding MAPC agreement(s) or scheme(s) are not critically updated), the STA 91 may skip monitoring the following MAPC Announcement frame. During monitoring 912, the STA 91 may notice critical updates occurred for MAPC agreements or schemes (since the MAPC Update Indication field is 1), or critical updates occurs for the MAPC agreement(s) or scheme(s) the STA 91 is involved (since the MAPC Update Indication field indicates the corresponding MAPC agreement or schemes have been critically updated), the STA 91 may need to monitor the following MAPC Announcement frame and get the updated information. For example, based on the information carried by the MAPC element, the STA 91 may extract the MAPC scheme table as shown in FIG. 10. In this example, the associated AP 90 may coordinate with AP 1 1011 to AP 5 115 and provide several MAPC services. With AP1 1011, they may provide Co-BF and Co-RTWT. With AP 2 1012, they may provide Co-BF and Co-SR. With AP 3 1013, they may provide Co-TDMA. With AP 4 1014, they may provide Co-NPCA. With AP 5 1015, they may provide Co-SR.

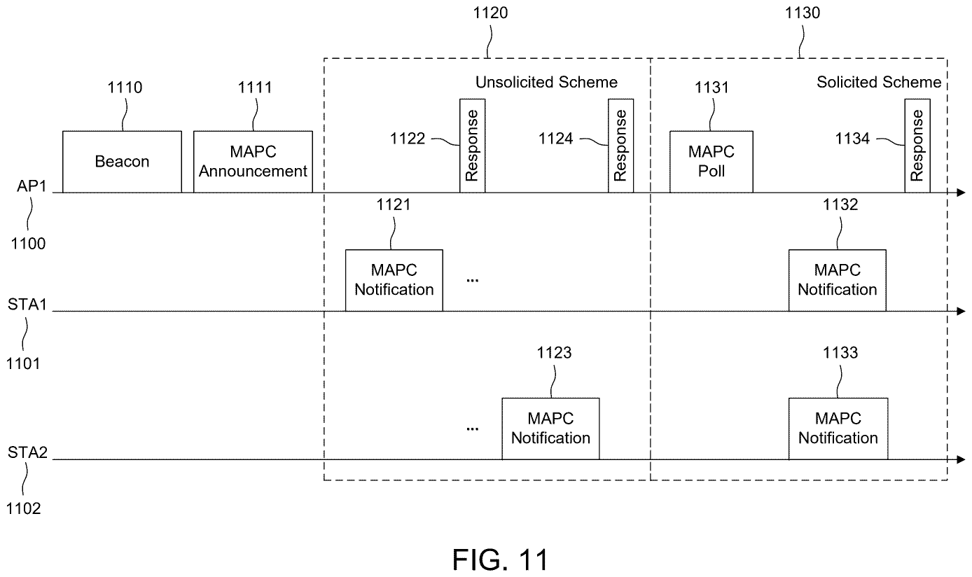

An AP 1100 may poll one or more non-AP eligible STAs 1101 or 1102 (STAs with corresponding MAPC scheme capability) to check if they may be interested in one or more upcoming MAPC transmissions. In one method as shown in FIG. 11, an MAPC Poll frame 1131 sent by the AP 1100 may be a type of Trigger frame which may trigger MAPC Notification transmissions 1132 sent by STA 1101 or 113 sent by STA 1102 with resource allocation so that the polled STAs may respond by TB PPDU on the allocated resource. In one method, the MAPC Poll frame may poll one STA at a time. To poll multiple STAs, the AP and polled STAs may exchange MAPC Poll frame/MAPC Notification frame/field sequentially.

On reception of the MAPC Notification 1132 or 1133, in one method, the AP 1100 may not respond to the MAPC Notification. In one method, the AP 1100 may respond with a response 1134 to the MAPC Notification. In one method, the response may be acknowledgment frames. In one method, the response may be MAPC Notifications carried in MAC frames or MAC headers.

A MAPC Notification Frame is disclosed herein.

MAPC Notification frame may be an Ultra High Reliability (UHR) (Protected) Action frame or a Public Action frame. The MAPC Notification frame format is shown in Table 26. The Category and (Protected) UHR Action field (or Public Action field) are defined in description related to Table 6. The Dialog Token field is a set to a nonzero value chosen by the non-AP STA to identify the MAPC notification transaction.

TABLE 26
MAPC Notification frame action field format.

| Order | Information |
|---|---|
| 1 | Category |
| 2 | (Protected) UHR Action (or |
| | Public Action) |
| 3 | Dialog Token |
| 4 | MAPC Scheme Control |
| 5 | Per MAPC Scheme Info |
| 6 | Per AP Measurement |
| 7 | Buffer Status Report |

The MAPC Scheme Control field format is shown in Table 27. Each field may indicate if the corresponding MAPC scheme is enabled at the non-AP STA side. With this method (refer as Method I), if a scheme is disabled by the non-AP STA, the AP may not perform the corresponding MAPC transmission to the non-AP STA. Or each field may indicate if the non-AP STA intends to participate the corresponding MAPC scheme. With this method (refer as Method II), if a scheme is disabled by the non-AP STA, but the non-AP STA is capable of the MAPC scheme, the AP may still perform the corresponding MAPC transmission to the non-AP STA.

TABLE 27
MAPC Scheme Control field format.

| | | | | |
|---|---|---|---|---|
| Co-BF | Co-SR | Co-RTWT | Co-TDMA | Co-NPCA |
| Enabled | Enabled | Enabled | Enabled | Enabled |

The Per MAPC Scheme Info field format is shown in Table 28. With Method I, the presence of each field may depend on the setting in the MAPC Scheme Control field. For example, if Co-BF Enable field in the MAPC Scheme Control field is set to yes, and the other fields are set to no, then the Per MAPC Scheme Info field may carry the Co-BF Parameters. Each Parameters field may carry a Recommended AP or a Recommended AP List. For example, if Co-BF is present, the non-AP STA may indicate the recommended AP(s) from the APs which are identified by the MAPC AP ID fields carried in the MAPC Announcement and supporting the MAPC scheme. In one method, the AP must follow the recommendation of the non-AP. In one method, the AP may determine the coordinated AP for that MAPC transmission. AP's determination may or may not be the recommended AP of the non-AP STA.

TABLE 28
Per MAPC Scheme Info field format.

| | | | | |
|---|---|---|---|---|
| Co-BF | Co-SR | Co-RTWT | Co-TDMA | Co-NPCA |
| Parameters | Parameters | Parameters | Parameters | Parameters |

The Per AP Measurement field may carry the SINR/SNR/RSSI/pathloss or other type of measurements from each coordinated AP identified in the MAPC Announcement. The measurement may be set to a special value to indicate the receive power from that coordinated AP is below a predefined threshold. When this value is set, the interference level between the coordinated AP and the non-AP STA may be considered as very low or negligible. The AP may use this information to perform non-AP pre-selection/grouping for a certain MAPC scheme.

The Buffer Status Report field may carry the buffer status report from the non-AP STA. The format of this field may be the same as that BSR Control field defined in IEEE P802.11-REVme/D7.0. The AP may use this information to perform non-AP selection/grouping for a certain MAPC scheme.

In an alternative method, the MAPC Scheme Control field and Per MAPC Scheme Info field carried in the MAPC Notification fame may be replaced by MAPC Control field and the Per MAPC Info field as shown in Table 29.

The MAPC Control field may carry the information whether the non-AP STA intents or enables one or more MAPC agreements. In one method, the field may be a bitmap. The length of the bitmap depends on the Number of Per MAPC Info field in the Common Info field of the MAPC Announcement transmitted by its associated AP. The n^{th} bit in the bitmap may be set to 1 (or 0) to indicate the non-AP STA may intend to participate the n^{th} MAPC agreement announced by the AP. In one method, the field may include one or more MAPC IDs or MAPC AP IDs to indicate the non-AP STA may intend to participate the MAPC agreement identified by the MAPC IDs and/or MAPC AP IDs announced by the AP. One or more Per AP MAPC Info field may be carried. The number of Per AP MAPC Info field carried may depend on the setting of the MAPC Control field. Each Per AP MAPC Info field may be corresponding to one MAPC agreement announced by the AP. The non-AP STA may indicate one or more agreed MAPC schemes for the MAPC agreement.

TABLE 29
MAPC Notification frame action field format II.

| Order | Information |
|---|---|
| 1 | Category |
| 2 | (Protected) UHR Action (or |
| | Public Action) |
| 3 | Dialog Token |
| 4 | MAPC Control |
| 5 | Per MAPC Info |
| 6 | Per AP Measurement |
| 7 | Buffer Status Report |

MAPC Notification Control field is described herein.
MAPC Notification may be defined as a subfield and carried in a MAC header. For example, a MAPC Notification Control subfield may be carried in the HT Control field in the MAC header. We may use HE variant HT Control field as an example to show how to carry the MAPC notifications. With this format, 4 bits may be used as Control ID subfield. A value of Control ID may be used to indicate this is the MAPC Notification Control field as shown in Table 30. In this example, Control ID set to 10 may indicate the Control field is a MAPC Notification Control field. Note, other value may be used instead.

TABLE 30
Control ID subfield values.

| Control ID | |
|---|---|
| Value | Meaning |
| . . . | . . . |
| 9 | AP assistance request (AAR) |
| 10 | MAPC Notification |
| . . . | . . . |

Due to the limited size of the MAC header, the MAPC Notification Control subfield has up to 26 bits to carry information. An exemplary MAPC Notification Control field format is shown in Table 31. With this example, a non-AP STA may be able to notify its associated AP that it may want to participate a MAPC scheme with a OBSS AP. The AP ID subfield may indicate the OBSS AP ID which was identified in a MAPC AP ID field in the MAPC Announcement transmitted by the associated AP. The MAPC Scheme subfield may indicate the MAPC scheme the non-AP STA plan to participate. Note, the MAPC scheme should be supported by the OBSS AP. The MAPC Measurement may be a measurement (e.g., SINR/SNR/SIR/Pathloss/RSSI) the non-AP STA measured regarding to the OBSS coordinated AP. The measurement may be set to a special value to indicate the receive power from that coordinated AP is below a predefined threshold. When this value is set, the interference level between the coordinated AP and the non-AP STA may be considered as very low or negligible. Note, we included three subfields in the MAPC Notification Control subfield as example. Other fields/subfields mentioned in Section 2.2.8.2 may be included in the MAPC Notification Control subfield.

TABLE 31
Control Information subfield format in a MAPC Notification
Control subfield in a MAPC Notification subfield.

| | | |
|---|---|---|
| AP ID | MAPC Scheme | MAPC Measurements |

The MAPC Notification Control subfield may be carried in the MAC header of a management frame, a data frame and a Control Wrapper frame. A non-AP STA may use those frames to notify its associated AP the MAPC related information.

Note, we use HT Control field as an example to describe the design of MAPC Notification Control subfield. There may be other field in the MAC header which may contain the MAPC Notification Control subfield.

MAPC Notification in Multi-STA BA Frame is described herein.

Multi-STA BlockAck (M-BA) frame is repurposed to carry feedback information in 802.11bn. MAPC Notification information may be carried in the M-BA frame.

In the AID TID Info subfield (Table 4) in the BA Information field of the M-BA, the following setting may be used to indicate the M-BA frame sent to an AP may carry feedback information:
The AID11 subfield may be set to 0 to indicate this M-BA frame is sent to an AP.
The Ack Type subfield is set to 0 and the TID subfield is equal to 13 to indicate the M-BA frame carries feedback information.

When the M-BA carries the feedback information, the Per AID TID Info subfield is for example, given in Table 32.

TABLE 32
Per AID TID Info subfield format if the AID11 subfield is not
2045 and if the combination of the Ack Type subfield is equal
to 0 and the TID subfield is equal to 13 respectively.

| | | |
|---|---|---|
| AID TID Info | Block Ack Starting | Feedback |
| | Sequence Control | |

Some bits in the Block Ack Starting Sequence Control subfield may be used to indicate the feedback type. For example, B4, B5 and/or B6 may be used to indicate the feedback type (referred as Feedback Type Indication subfield). One example is shown in Table 33. The bits set to 0 may indicate the Feedback subfield carries unavailability information. The bits set to 1 may indicate the Feedback subfield carries MAPC notification information. The bits set to 2 may indicate the Feedback subfield carries low latency related information.

TABLE 33
Feedback Type indication.

| B4-B5(or B6) of BA | |
|---|---|
| Sequence Control subfield | Meaning |
| 0 | Unavailability feedback |
| 1 | MAPC notification |
| 2 | LL Indication |
| . . . | . . . |

The Feedback subfield with MAPC notification may have the format as show in Table 34 and Table 35. The detailed explanation of each subfield mentioned in the tables are the same as that shown in Section 2.2.8.2. Alternatively, subset of subfields included in the Per MAPC Scheme Info field (or Per MAPC Info field), Per AP Measurement field, Buffer Status Report field may be included in the Feedback field contained in the M-BA.

TABLE 34
MAPC Notification Feedback subfield format I.

| | | | |
|---|---|---|---|
| | Per MAPC | Per AP | Buffer Status |
| MAPC Control | Scheme Info | Measurement | Report |

TABLE 35
MAPC Notification Feedback subfield format II.

| | | | |
|---|---|---|---|
| MAPC Control | Per MAPC Info | Per AP | Buffer Status |
| | | Measurement | Report |

In one method, a STA (e.g., non-AP STA or AP) may use the Feedback field of the M-BA to carry low latency related information by setting the feedback type indication bits in the Block Ack Starting Sequence Control subfield to a special value (e.g., 2 as shown in Table 33. Then the Feedback subfield may carry:
TID subfield: this subfield may indicate the traffic ID (TID) used for the low latency traffic. In one method, the other fields/subfields included in the same Feedback subfield may be the parameters regarding this TID.
AC subfield: this subfield may indicate the access category (AC) used for the low latency traffic. In one method, the other fields/subfields included in the same Feedback subfield may be the parameters regarding this AC.
Direction indication: this subfield may be used to indicate whether the low latency traffic is a UL traffic, a traffic to a peer non-AP STA, a DL traffic, or a AP to AP traffic.
Delay Bound: this subfield contains an unsigned integer that specifies the maximum amount of time, in microseconds, targeted (see the MSDU Delivery Ratio field for more details on the delay and the targeted deliver ratio) to transport an MSDU or A-MSDU belonging to the traffic flow described by this element, measured between the time marking the arrival of the MSDU, or the first MSDU of the MSDUs constituting an A-MSDU, at the local MAC sublayer from the local MAC SAP and the time of completion of the successful (re) transmission of the MPDU containing the MSDU to the destination.
The Expiration Time: the latest time that LL data may need to leave the MAC of receiver.
The Expiration Time Bound: minimum and/or maximum of the latest time that the LL data packets associated with the AC or TID may be required to leave the MAC of receiver. Note the expiration time can be used to help the head of line (HOL) issues at the receiver side.
In one method, one or more fields defined in BSR Control field in IEEE P802.11-REVme/D7.0may be carried in the Low Latency Feedback subfield. For example, the ACI Bitmap, Delta TID, ACI High, Scaling Factor, Queue Size High, and Queue Size All subfields may be carried in the newly defined Low latency Feedback subfield. The meaning of the above-mentioned subfields is defined in IEEE P802.11-REVme/D7.0.
In one method, the M-BA frame may be generalized to carry more feedback. For example, the Feedback Type Indication format may be defined as show in Table 36. The detailed values for the Feedback Type Indication may be modified.
In this example, when the Feedback Type Indication is set to 3, a Buffer Status Report (BSR) may be carried in the Feedback field. In one method, the BSR may be defined the same as BSR Control field in IEEE P802.11-REVme/D7.0. In one method, the BSR may be an enhanced version of the BSR Control field defined in [1]. For example, TID field may be added to indicate the buffer status is related to one or more TID values. One or more subfields currently defined in the BSR Control subfield may have more bits to carry larger queue size.
In this example, when the Feedback Type Indication is set to 4, an Unequal Modulation Report (UMR) may be carried in the Feedback field. The UMR may suggest the receiving STA to perform unequal modulation transmission to the transmitting STA in a later transmission. Here the transmitting STA refers to the STA which transmit the UMR, and the receiving STA refers to the intended receiving STA of the UMR. In addition, the UMR may carry average per spatial stream SNR or SINR measured at transmitting STA side. Or the UMR may carry the suggested per spatial stream modulation indices by the transmitting STA. In one method, the receiving STA may choose the per spatial stream modulation order based on the report when it performs unequal modulation transmission to the transmitting STA later. In one method, the receiving STA may transmit a Trigger frame to trigger the transmission from the transmuting STA. In this case, the receiving STA may choose the per spatial stream modulation order based on the report and assign them in the Trigger frame to the transmitting STA. To distinguish the two use cases (case 1: the measurement will be used to set modulation order in the transmission from the receiving STA to the transmitting STA; case 2: the measurement will be used in a Trigger frame for the receiving STA to set modulation orders in the Trigger frame to trigger a trigger based transmission from the transmitting STA to the receiving STA), a TB Indication may be carried in the UMR Feedback field.
In this example, when the Feedback Type Indication is set to 5, a Distributed RU Report (DRU) may be carried in the Feedback field.

TABLE 36
Feedback Type Indication II.

| B4-B5(or B6) of BA | |
|---|---|
| Sequence Control subfield | Meaning |
| 0 | Unavailability feedback |
| 1 | MAPC notification |
| 2 | LL Indication |
| 3 | Buffer Status Report |
| 4 | Unequal Modulation Report |
| 5 | Distributed RU Report |
| . . . | . . . |

A MAPC Poll Trigger frame is disclosed herein.

MAPC Poll frame may be a Trigger frame. It may reuse the existing BSRP Trigger frame, BSRP Trigger frame with GI field set to 3, MU-RTS frame, or other types of Trigger frame. In one method, one field in the Trigger frame (e.g., BSRP Trigger frame, or MU-RTS Trigger frame or other type of Trigger frame) may be used to indicate the Trigger frame may be a MAPC Poll Trigger frame which polls a non-AP STA to transmit the MAPC Notification.

Non-AP STA Pre-Selection and Grouping is disclosed herein.

In one method, non-AP STA selection and grouping for some MAPC scheme may be a two-step process. The first step is the non-AP STA pre-selection/grouping procedure. It may be performed when an AP receives one or more MAPC Notifications from one or more non-AP STAs. Based on the measurements carried in the MAPC Notifications, the AP may know the RSSI/pathloss between the non-AP STA and other coordinated APs. Based on this information, the AP may estimate the expected signal to noise ratio (SIR) when the coordinated AP and itself transmit concurrently to the non-AP STA. The second step may be performed in TXOP level and not the focus of this disclosure.

The exemplary pre-selection/grouping procedure is shown in 12. In this example, STA1 is associated with AP1 1200, AP2 1202, and AP3 1203 negotiated before and set up several MAPC agreements. For example, AP1 1200 and AP2 1202 had a MAPC agreement with Co-SR. AP1 1201 and AP3 1203 had a MAPC agreement with Co-SR. In one method, when APs have active MAPC agreements for all MAPC schemes or a set of MAPC schemes (e.g., Co-SR, Co-BF), they may keep using the same transmit power for their Beacon frames.
STA1 1201 may receive a MAPC Announcement 1210 from AP1 1200, which includes:
   MAPC agreement with AP2 1202 for Co-SR.
   MAPC agreement with AP3 1202 for Co-SR.
   AP2's transmit power, and estimated transmit time for Beacon frame.
   AP3's transmit power, and estimated transmit time for Beacon frame.
STA1 1201 may be capable of performing Co-SR. STA1 1201 may intend to participate in Co-SR due to its buffer data status, channel conditions or other conditions. STA1 1201 may then monitor the Beacon frame transmitted by AP2 1202 and AP3 1203 respectively. STA1 1201 may measure the RSSI, Pathloss, SNR, or other metrics based on the received Beacon frame 1211 from AP2 1202 and received Beacon frame 1212 from AP3 1203.
STA1 1201 may acquire the wireless medium measurements and transmit a MAPC Notification frame 1213 to AP1 1200. In this example, STA1 1201 may indicate it intends to participate the Co-SR transmission under the MAPC agreement with AP2 1202, and it intends to participate the Co-SR transmission under the MAPC agreement with AP3 1203. Unsolicited procedure is used in this example, but solicited procedure may be utilized. In the MAPC Notification frame 1213, STA1 may indicate its measured RSSI or Pathloss regarding AP2 1202 and AP3 1203 respectively. We may refer them as RSSI_AP2, RSSI_AP3, Pathloss_AP2, Pathloss_AP3.
On reception of the MAPC Notification frames 1213 from STA1 1201, and other notifications from other STAs, AP1 1200 may try to pre-select the potential Co-SR recipient under MAPC agreement with AP2 1202 and AP3 1203 respectively. The pre-selection procedure may depend on AP1's implementation. Here we disclose one possible way:
   AP1 1200 may have a predefined thresholds for each AP which set a MAPC agreement for Co-SR. In one example, the thresholds may be in the format of RSSI or pathloss. For example, Threshold_Pathloss_1 (TP1), Threshold_Pathloss_2 (TP2), Threshold_Pathloss_3 (TP3) (or Threshold_RSSI_1, Threshold_RSSI_2, Threshold_RSSI_3 etc. we use Pathloss threshold as example going forward and similar idea can be applied to other measurement metrics). We may have TP1>TP2>TP3. For each AP (e.g. AP2 1202 and AP3 1203) with Co-SR agreement, AP1 may pre-select/group its STAs by comparing the received Pathloss measurement with the predefined threshold. The AP may maintain a table such as 37 In this example, STA1's reported pathloss measurement regarding AP2 1202 is bigger than TP1, while its reported pathloss measurement regarding AP3 1203 is between TP3 and TP2. We show another STA, i.e., STA2 in the table. STA2's reported pathloss measurement regarding AP2 is smaller than TP3, while its reported pathloss measurement regarding AP3 is between TP2 and TP1. The larger the pathloss measurement is the less the interference from the corresponding AP is. The STAs under each grid may be considered as a group. When AP1 is coordinating with AP2 to perform Co-SR transmissions, it may choose the STAs from the largest pathloss group, i.e., the last column. Under certain conditions, if the APs may allow a little bit higher interference level, AP1 may consider the STAs in the third column, the second column and the first column in order. Note, we use three thresholds in this example, other numbers of thresholds may be used.

According to various embodiments, the AP1 1200 may select for a given STA, the AP which corresponds to the best quality of reception or all APs for which a quality of reception is greater or lower than a threshold, or a mix of different conditions (e.g. workload, energy saving, randomized selection to balance workload among APs . . . ), providing that a quality of reception for a selected AP is greater than a threshold.

TABLE 37
non-AP STA pre-selection/grouping table maintained at the AP side.

| AP ID | Pathloss < TP3 | TP3 <= Pathloss < TP2 | TP2 <= Pathloss < TP1 | TP1 <= Pathloss |
|---|---|---|---|---|
| AP2 | STA2 | | | STA1 |
| AP3 | | STA1 | STA2 | |

Note, we use Co-SR as examples to explanation the pre-selection/grouping procedure based on the measurement provided in the MAPC Notification frame/field. Other MAPC schemes, such as Co-BF, Co-RTWT, Co-TDMA, and Co-NPCA may use similar procedure based on the same or different measurement.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and memory, the circuitry being operable (e.g., configured) to process the disclosed method, with a computer program product comprising program code instructions and with a non-transitory computer-readable storage medium storing program instructions. Besides, any characteristic, variant or embodiment described for a WTRU is compatible with an (e.g., infrastructure) network element of the cellular network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

The content of each of the following references is incorporated by reference herein in its entirety:
Draft IEEE Standard for Information technology—Telecommunications and information exchange between systems Local and metropolitan area networks-Specific requirements, “Part 11: Wireless LAN Medium Access Control (MAC) and Physical Layer (PHY) Specifications”, IEEE P802.11-REVme/D7.0, August 2024, 613 pages
Draft Standard for Information technology—Telecommunications and information exchange between systems Local and metropolitan area networks-Specific requirements; Part 11: Wireless LAN Medium Access Control (MAC) and Physical Layer (PHY) Specifications; Amendment 1: Enhancements for High Efficiency WLAN, IEEE P802.11ax/D8.0 (October 2020), 820 pages
Draft Standard for Information technology—Telecommunications and information exchange between systems Local and metropolitan area networks—Specific requirements, “Part 11: Wireless LAN Medium Access Control (MAC) and Physical Layer (PHY) Specifications; Amendment 8: Enhancements for extremely high throughput (EHT)”, IEEE P802.11be/D3.0 (January 2023), 999 pages
YU, “Specification Framework for TGbn,” IEEE 802.11-24/0209r5, September 2024 (2024-09-22), 17 pages

1. A method, performed by a wireless station (STA), the method comprising:
receiving, from a first Access Point (AP), a first frame that indicates Multiple Access Point (MAP) coordination information corresponding to the first AP and one or more second APs; and
transmitting, to the first AP, a second frame that indicates one or more MAP coordination schemes associated with one or more of the first and the second APs.

2. The method of claim 1, wherein the one or more second APs are Overlapping Basic Service Set (OBSS) APs with the first AP.

3. The method of claim 1, further comprising:
determining one or more received signal characteristics from the first AP and the one or more second APs; and
transmitting, to the first AP, the determined one or more received signal characteristics based on the one or more MAP coordination schemes indicated in the second frame.

4. The method of claim 3, wherein determining one or more signal characteristics includes measurement of one or more received signal characteristics from the first AP and the one of more second APs.

5. The method of claim 3, wherein each of the one or more received signal characteristics is associated with one or more MAP coordination schemes indicated in the second frame.

6. The method of claim 1, further comprising:
receiving, from the first AP, a poll frame, and
wherein the second frame is transmitted in response to the poll frame.

7. The method of claim 1, wherein the second frame is transmitted without any solicitation from the first AP.

8. The method of claim 1, wherein the one or more coordination schemes includes at least one of:
coordinated spatial reuse (Co-SR)
coordinated beamforming (Co-BF),
coordinated restricted target wake time scheme (Co-RTWT),
coordinated Time Division Multiple Access (Co-TDMA),
coordinated non-primary channel access (Co-NPCA).

9. The method of claim 1, wherein the second frame indicates that the STA may participate to one or more MAP coordination schemes.

10. The method of claim 1, wherein the first frame is a broadcast management frame.

11. The method of claim 1, further comprising enabling or disabling one or more MAP coordination schemes.

12. A wireless Station (STA) comprising circuitry, including a transmitter, a receiver, a processor, and memory, and configured to:
receive, from a first Access Point (AP), a first frame that indicates Multiple Access Point (MAP) coordination information corresponding to the first AP and one or more second APs; and
transmit, to the first AP, a second frame that indicates one or more MAP coordination schemes associated with one or more of the first and the second APs.

13. A first Access Point (AP) comprising circuitry, including a transmitter, a receiver, a processor, and memory, and configured to:
transmit, to one or more wireless Stations (STA), a first frame that indicates MAP coordination information corresponding to the first AP and one or more second APs; and
receive, from one or more wireless Stations (STA), a second frame that indicates one or more MAP coordination schemes associated with one or more of the first and the second APs.

14. The first AP of claim 13, wherein the one or more second APs are Overlapping Basic Service Set (OBSS) APs with the first AP.

15. The first AP of claim 13, being further configured to receive from one or more STAs one or more received signal characteristics associated with the one or more MAP coordination schemes indicated in the second frame.

16. The first AP of claim 13, being further configured to set an MAPC agreement with each of the second APs.

17. The first AP of claim 16, wherein the MAPC agreement with each of the second AP refers to one or more coordination schemes.

18. The first AP of claim 16, wherein the first AP is configured to store to one or more coordination schemes associated with each of the second AP.

19. The first AP of claim 13, wherein the one or more coordination schemes includes at least one of:
coordinated spatial reuse (Co-SR),
coordinated beamforming (Co-BF),
coordinated restricted target wake time scheme (Co-RTWT),
coordinated Time Division Multiple Access (Co-TDMA), and
coordinated non-primary channel access (Co-NPCA).

20. The first AP of claim 13, being further configured to enable or disable one or more MAP coordination schemes.
